(19) United States
(12) Patent Application Publication
(10) Pub. No.: US 2020/0103121 A1
(43) Pub. Date: Apr. 2, 2020

(54) OVENS AND ARTICLES WITH OLEOPHOBIC SURFACE COATINGS

(71) Applicants: Atieh Haghdoost, Castro Valley, VA (US); Mehdi Kargar, Castro Valley, CA (US); Shahrokh Motallebi, Los Gatos, CA (US); Meisam Movassat, Hayward, CA (US)

(72) Inventors: Atieh Haghdoost, Castro Valley, VA (US); Mehdi Kargar, Castro Valley, CA (US); Shahrokh Motallebi, Los Gatos, CA (US); Meisam Movassat, Hayward, CA (US)

(21) Appl. No.: 16/373,218

(22) Filed: Apr. 2, 2019

Related U.S. Application Data
(60) Provisional application No. 62/651,647, filed on Apr. 2, 2018.
(60) Provisional application No. 62/805,880, filed on Feb. 14, 2019.

(51) Int. Cl. C09D 5/20

(52) U.S. Cl. CPC F24C 15/005; C09D 7/63; H05B 6/6402; B05D 3/0254; B05D 1/28; C09D 165/02; C09D 183/06; C09D 7/61; F24C 15/10

(57) ABSTRACT

Certain embodiments described herein are directed to ovens and articles that comprise an oleophobic surface coating on one or more surfaces. In some examples, the coating can be oleophobic and provide easy-to-clean performance for at least ten cycles. Methods used to produce the coatings on the ovens and articles are also described.

### PRIORITY AND RELATED APPLICATIONS

This application claims priority to, and the benefit of, each of U.S. 62/651,647 filed on Apr. 2, 2018 and U.S. 62/805,880 filed on Feb. 14, 2019. This application is also related to commonly owned patent application U.S. 62/805,886 filed on Feb. 14, 2019 and to commonly owned application filed on even date herewith, bearing serial number U.S. Ser. No. 16/373,211 and entitled “OLEOPHOBIC COATINGS AND WIPES AND APPLICATORS USED TO PRODUCE THEM” and bearing attorney docket number MAXTER-700710, which claims priority to U.S. 62/651,647 and U.S. 62/805,886. The entire disclosure of each of these applications is hereby incorporated herein by reference for all purposes.

### TECHNOLOGICAL FIELD

Certain embodiments are directed to ovens and articles comprising an oleophobic surface coating. In some instances, the oleophobic surface coating is an easy-to-clean coating.

### BACKGROUND

Oven surfaces are often subjected to food material that can leave residue on the oven surfaces. The residue can be difficult to remove and often requires the use of oven cleaners that include abrasive materials. In many cases, not all residue in the oven can be removed even when the abrasive materials are used.

### SUMMARY

Certain aspects, configurations, embodiments and examples are described of oven and article surfaces that comprise an oleophobic surface coating that provides easy-to-clean performance in a cleanability test for a desired number of cycles and does not off gas any halogenated compounds when the surface comprising the oleophobic surface coating is heated to a temperature of 350 degree Celsius. The exact number of cycles where the surface coating may provide the easy-to-clean performance may vary and is typically at least one cycle or ten cycles or more. If desired, the application of the coating materials to the surface can be performed to restore the surface coating properties.

In an aspect, an oven comprising a cooking cavity and an oleophobic surface coating on at least one surface of the cooking cavity is described. In some configurations, the oleophobic surface coating provides easy-to-clean performance in a cleanability test for at least ten cycles and does not off gas any halogenated compounds when the surface comprising the oleophobic surface coating is heated to a temperature of 350 degree Celsius.

In another aspect, an oven comprises a cooking cavity and an oleophobic surface coating on a surface of the cooking cavity, wherein the oleophobic coating is produced using a wipe or an applicator. For example, an applicator comprising a carrier material and a handle coupled to the carrier material can be used. The carrier material can comprise retained coating material and transfer at least some of the retained coating material from the carrier material to a contacted surface when the applicator and carrier material are pressed against the contacted surface. The coating material can provide an oleophobic surface coating on the contacted surface. For example, the oleophobic surface coating provides easy-to-clean performance in a cleanability test for at least ten cycles and does not off-gas any hazardous compounds when the oleophobic surface coating is heated to a temperature of 350 degree Celsius.

In an additional aspect, a process for producing an oleophobic coating that does not off-gas any hazardous compounds when the oleophobic surface coating is heated to a temperature of 350 degree Celsius and provides easy-to-clean performance for at least ten repeated cycles of a cleanability test comprises depositing a coating material on a surface, and curing the deposited coating material to provide the oleophobic coating that provides the easy-to-clean performance for at least ten repeated cycles of the cleanability test. As noted herein, the coating material can be deposited using wipes, applicators, by dip coating, flow coating, spray coating, spin coating or other coating techniques and devices.

In another aspect, an article comprising a surface configured to transfer heat to an object thermally coupled to the surface is described. In some instances, the surface comprises an oleophobic surface coating that provides easy-to-clean performance in a cleanability test for at least ten cycles and does not off-gas any hazardous compounds when the oleophobic surface coating is heated to a temperature of 350 degree Celsius.

Additional aspects, embodiments, configurations, examples and illustrations are described in more detail below.

### BRIEF DESCRIPTION OF THE SEVERAL VIEWS OF THE DRAWINGS

Certain configurations are described below with reference to the accompanying drawings in which:

FIG. 1A is an illustration of an oven, in accordance with some embodiments;

FIG. 1B is another illustration of an oven, in accordance with some embodiments;

FIG. 1C is an additional illustration of an oven, in accordance with certain examples;

FIG. 2 is an illustration of an oven, in accordance with some embodiments;

FIG. 3 is an illustration of a microwave oven, in accordance with some examples;

FIG. 4 is an illustration of a cooking article, in accordance with some embodiments;

FIG. 5 is another illustration of a cooking article, in accordance with some embodiments;

FIG. 6A is an illustration of a wipe in a package, in accordance with some examples;

FIG. 6B is an illustration of a roll of wipes, in accordance with some embodiments;

FIG. 7A is a general structure of an organofunctional silane, in accordance with certain examples;

FIG. 7B is a general structure of an epoxysilane, in accordance with some embodiments;

FIGS. 8A, 8B, 9A, 9B, 10A, 10B, 11A, 11B and 12A are various illustrations of applicators that can be used to apply the coating materials, in accordance with certain embodiments;

FIGS. 12B and 12C are illustrations of a kit that can be used to apply the coating materials, in accordance with some examples;

FIGS. 13A, 13B, 14A and 14B shows images of contact angle measurement for various tested samples, in accordance with some embodiments;

FIG. 15 is a graph showing thermal gravimetric analysis of a coating, in accordance with some examples;

FIGS. 16A, 16B, 16C and 16D are images showing various tested surfaces, in accordance with some embodiments;

FIGS. 17A and 17B are XPS spectra, in accordance with some examples; and

FIGS. 18A and 18B are two images of the 3D structure of a coating taken by atomic force microscopy, in accordance with some embodiments'

FIG. 19A is an image of an oven with an exposed heating element, in accordance with some examples;

FIG. 19B is an image of an oven with a covered heating element, in accordance with some embodiments;

FIG. 20A shows an image of a coated enamel surface before a cleanability test; and

FIG. 20B shows an image of a coated enamel surface after ten cycles of a cleanability test. It will be recognized by the skilled person in the art, given the benefit of this disclosure that the dimensions of the applicators, wipes, etc. are not necessarily to scale. The exact dimensions and configurations may vary as desired.

### DETAILED DESCRIPTION

Certain embodiments are described that are directed to ovens and cooking articles that comprise a coating and a wipe/applicator that comprises one or more materials that can be applied to a surface of the oven. Contact of the wipe by the oven surface can result in transfer of at least some of the material from the wipe to the oven surface leaving behind the material on the oven surface. The material on the oven surface can be used to form a coating which may provide one or more desired properties including, but not limited to, oleophobicity, a coating that does not off-gas up to about 350 degrees Celsius and/or a coating which is easy to clean. Various illustrations of ovens, wipes, materials retained by the wipes, oven coatings produced using the wipes and applications of the wipes and oven coatings are described in more detail below. For ease of description, the components of the wipes and resulting oven coatings are described separately below in various sections. This separation is not intended to limit or require the wipe or the oven coating to have only those components described in any one section or paragraph. The person having ordinary skill in the art, given the benefit of this disclosure, will recognize that many different combinations of materials can be present in the wipes and in the oven coatings. The surface coatings are generally stable and do not degrade to any substantial degree under heating. For example, a weight loss of an oleophobic surface coating can be less than 1 percent when the oleophobic surface coating is heated to temperatures between 300 degrees Celsius to 400 degrees Celsius for sixty minutes.

In certain examples, a wipe that is moistened with one or more materials can be used to transfer the material from the wipe to a surface. Applicators and other devices can be used to assist in wiping the surface. In other instances, the material can be sprayed or otherwise deposited on a surface and a wipe or a brush, which may be dry or may also include the material, can be used to spread the material around. Applicators and other devices can be used to assist in spreading of the material using the wipe.

In some embodiments, a coating is produced on the oven surface which is generally considered an oleophobic coating. Oleophobic coatings have a contact angle of more than 90 degrees with a droplet of grape seed oil as measured by the ASTM D7490-13 standard.

In other embodiments, a coating is produced on the oven surface that does not result in any off-gassing of hazardous halogenated materials, e.g., fluorinated materials, when the oven surface including the coating is heated to a temperature of about 350 degrees Celsius. For example, the coating can be present on an oven surface to enhance cleanability of the oven surface. In some instances, debris, residue or other materials may end up on the oven surface during or after heating of the surface. The presence of the coating permits removal of the debris or residue in an easy manner. Where the coating does not provide any off-gassing of halogenated materials, the coating may also be oleophobic as noted herein.

In other examples, the coating on the oven surface may provide “easy-to-clean” performance in a cleanability test for a certain number of cycles, e.g., 1 cycle, up to 5 cycles, up to 10 cycles, 10 cycles or more, etc. While there is no exact standard used to determine easy-to-clean performance, as used herein, a surface coating is considered to meet the easy-to-clean performance criteria in a cleanability test if a cleaning process with the following steps can completely remove the residue of burnt ketchup (burned at 230 degrees Celsius to 300 degrees Celsius for 30 minutes to 1 hour after adding about one gram of ketchup to the surface as a spot) from the oven surface that includes the coating: (1) Cleaning is performed using a soft cloth or a Surface-care sponge (cleaning Scouring Sponge or abrasive sponge such as Green 3M Sponge should not be used for cleaning); (2) cleaning is performed either without any liquid or in the presence of hot water, mild detergent, or liquid abrasive cleaner (oven cleaner or other harsh chemicals should not be used for cleaning); the maximum allowable force for cleaning is four (4) kgf, and the oven surface can be wiped up to fifteen (15) separate times for removing the residue. If all residue is removed from the surface under these conditions, then the surface is considered an easy-to-clean surface. Performing of these steps is considered a single cycle under the cleanability test. In a successive cycle, about one gram of ketchup is applied to the same spot on the surface, burned and then the cleaning process is repeated. Where the coating provides easy-to-clean performance, it may also be oleophobic. Where the coating provides easy-to-clean performance and is oleophobic, it may also not result in any off-gassing when the oven surface is heated up to about 350 degrees Celsius. Where the coatings are used in ovens, the oven coating desirably can be subjected to ten or more cleaning cycles without substantial loss of the coating on the oven surface.

Ovens and Articles

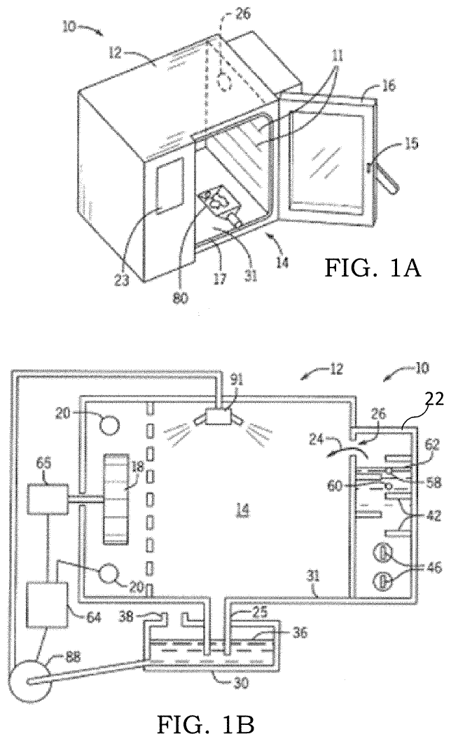

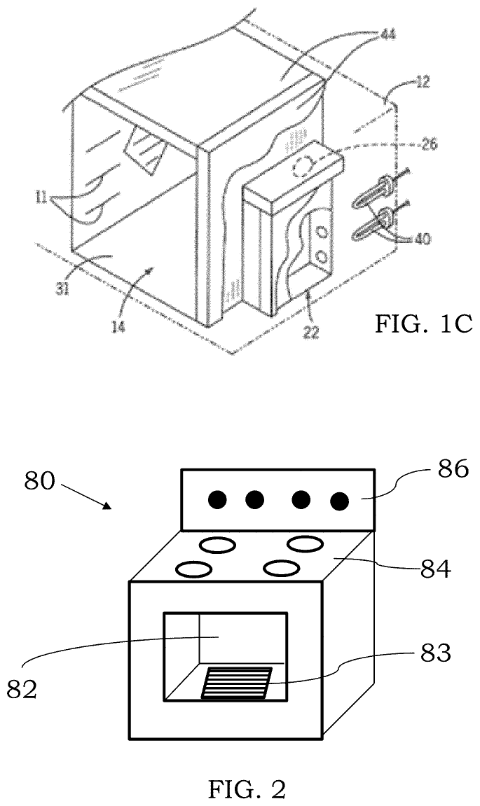

The coatings described herein can be present on conventional ovens, convection ovens, steam ovens, microwave ovens, toaster ovens or other ovens that comprise a heating/cooking element or heating source. Various illustrations are shown in connection with FIGS. 1A-3.

In certain examples, an oven generally comprises a cooking cavity and an optional cooktop. The cooking cavity may comprise an oleophobic surface coating on at least one surface of the cooking cavity. For example, the oleophobic surface coating can provide easy-to-clean performance in a cleanability test for at least ten cycles and does not off gas any halogenated compounds when the surface comprising the oleophobic surface coating is heated to a temperature of 350 degree Celsius. The cleanability test is described above with a single cycle representing performance of each of the steps of the cleanability test.

In some embodiments, the exact material used to provide the surface coating may vary and the materials used to provide the surface coating may be altered or otherwise not present in the same state or form in the coating materials and in the cured coating. For example, the coating materials may covalently bond with the surface, react with other materials in the coating materials or otherwise end up in a different form, structure or arrangement in the cured coating. In some instances, the coating materials may be present in a solution, which may be an aqueous solution, an organic solution or combinations thereof.

In some examples, the oleophobic surface coating on an oven surface comprises, or is produced using, one or more of parylene, an organofunctional silane, a fluorinated organofunctional silane, fluorinated organofunctional siloxane, organo-functional oligomeric siloxane, organofunctional resins, hybrid inorganic organofunctional resins, low-surface-energy resins, organofunctional polyhedral oligomeric silsesquioxane (POSS), hybrid inorganic organofunctional POSS resins, fluorinated oligomeric polysiloxane, organofunctional oligomeric poly siloxane, hybrid inorganic organofunctional oligomeric poly siloxane, fluorinated organofunctional silicone copolymers, organofunctional silicone polymers, hybrid inorganic organofunctional silicone polymers, organofunctional silicone copolymers, hybrid inorganic organofunctional silicone copolymers, fluorinated polyhedral oligomeric silsesquioxane (FPOSS), non-volatile linear and branched alkanes, alkenes and alkynes, esters of linear and branched alkanes, alkenes and alkynes, perfluorinated organic material, silane coupling agents, fluorinated alkylsiloxane, organofunctional resins, hybrid inorganic organofunctional resins, silicone polymers, surface-modified inorganic particles, fluorinated alkylsilane, fluorinated based organo-functional silane, fluorinated based organo-functional siloxane, polydimethylsiloxane, fluorinated organo-functional oligomeric siloxane, polymer blends, aqueous preparation of an organofunctional silane system, organofunctional polysiloxane, silane based sol-gel system, fluoroalkysilane, hydrolyzable inorganic ethoxysilyl groups, sol-gel systems, silane system, functionalized silanol groups, other similar groups, aqueous, alcohol-free products of epoxysilanes, or any combination thereof.

In other instances, the oleophobic surface coating on an oven surface comprises, or can be produced using, a material comprising carbon, fluorine, and silicon to provide an oleophobic surface coating that is a crosslinked mesh on the surface.

In additional examples, the oleophobic surface coating on an oven surface comprises, or can be produced using, at least particle comprising silica (SiO2) particles, platinum oxide (Pt2O), alumina particles (Al2O3), silicon carbide (SiC), single wall carbon nanotubes (SWCNTs), multi-wall carbon nanotubes (MWCNTs), diatomaceous earth (DE), boron nitride (BN), titanium oxide (TiO2), mixture of titanium/silica oxide (TiO2/SiO2, titanium inner core/silicon outer surface), ceramic particles, thermo-chromic metal oxides, diamond, particles formed by differential etching of spinodal decomposed glass, molybdenum disulfide (MoS2), boron nitride (BN), sulfides, selenides and tellurides (chalcogenides) of molybdenum, tungsten, niobium, tantalum, and titanium (eg. WS2, WSe2, MoSe2, TaSe2, TiTe2), monochalcenides (GaS, GaSe, SnSe), chlorides of cadmium, cobalt, lead, cerium, zirconium (eg. CdCl2, CoC12, PbCl2, CeF3, PbI2), borates (eg. Na2B4O7) sulfates (eg. Ag2SO4), black carbon, carbon black, engineered carbon-based nanomaterials, e.g., carbon nanotubes, fullerenes, graphene and any combination thereof. In some examples, the particles can be functionalized with a compound selected from the group comprising organofunctional silane, parylene, fluorinated alkylsilane, fluorinated alkylsiloxane, fluorinated based organo-functional silane, fluorinated based organo-functional siloxane, organofunctional resins, hybrid inorganic organofunctional resins, silicone polymers, polydimethylsiloxane, organofunctional silicone polymers, organofunctional silicone copolymers, fluorinated organofunctional silicone copolymers, organo-functional oligomeric siloxane, fluorinated organo-functional oligomeric siloxane, organofunctional polyhedral oligomeric silsesquioxane (POSS), fluorinated polyhedral oligomeric silsesquioxane (FPOSS), fluorinated oligomeric polysiloxane, organofunctional oligomeric poly siloxane, fluorinated organofunctional silicone copolymers, organofunctional silicone polymers, hybrid inorganic organofunctional silicone polymers, organofunctional silicone copolymers, hybrid inorganic organofunctional silicone copolymers, non-volatile linear and branched alkanes, alkenes and alkynes; esters of linear and branched alkanes, alkenes and alkynes, perfluorinated organic material, silane coupling agents, organofunctional silane systems, and any combinations thereof.

In additional instances, the oleophobic surface coating on the oven comprises, or can be produced using, a surfactant comprising alkylated and heavily alkylated quaternary ammonium salts, perfluorinated organo functional quaternary ammonium salts, Cetylpyridinium chloride, Lauryl methyl gluceth-10 hydroxypropyl dimonium chloride, Domiphen bromide, Benzododecinium bromide, Octenidine dihydrochloride, Fluoro-surfactant products, Sulfonates, Sulfates; Carboxylates for example Sodium stearate, Sodium lauroyl sarcosinate, Carboxylate-based fluorosurfactants such as Perfluorononanoate, Perfluorooctanoate (PFOA or PFO), Sodium alkylbenzene sulfonates, Sodium stearate, Potassium alcohol sulfates, Alcohol ethoxylates, Nonylphenoxy polyethylenoxy alcohols, Ethylene oxide/propylene oxide block copolymers, Fatty alcohol ethoxylates for example Narrow-range ethoxylate, Octaethylene glycol monododecyl ether, and Pentaethylene glycol monododecyl ether, Alkylphenol ethoxylates (APEs) for example Nonoxynols and Triton X-100, Special ethoxylated fatty esters and oils; Ethoxylated amines and/or fatty acid amides for example Polyethoxylated tallow amine, Cocamide monoethanolamine, and Cocamide diethanolamine; Terminally blocked ethoxylates for example Poloxamers, Fatty acid esters of polyhydroxy compounds, Fatty acid esters of glycerol for example Glycerol monostearate and Glycerol monolaurate, Fatty acid esters of sorbitol for example Sorbitan monolaurate, Sorbitan monostearate, and Sorbitan tristearate, Fatty acid esters of sucrose; Alkyl polyglucosides for example Decyl glucoside, Lauryl glucoside, and Octyl glucoside; Amine oxides for example Lauryldimethylamine oxide; Sulfoxides for example Dimethyl sulfoxide; Phosphine oxides for example Phosphine oxide, Sulfate, sulfonate, and phosphate esters; alkyl sulfates for example Ammonium lauryl sulfate and Sodium lauryl sulfate (sodium dodecyl sulfate, SLS, or SDS); Alkyl-ether sulfates for example sodium laureth sulfate (sodium lauryl ether sulfate or SLES), and sodium myreth sulfate; Docusate (dioctyl sodium sulfosuccinate); Perfluorooctanesulfonate (PFOS); Perfluorobutanesulfonate; Alkyl-aryl ether phosphates; Alkyl ether phosphates; pH-dependent primary, secondary, or tertiary amines; primary and secondary amines for example Octenidine dihydrochloride; Permanently charged quaternary ammonium salts for example Cetrimonium bromide (CTAB or Cetyltrimethyl ammonium bromide), Cetylpyridinium chloride (CPC), benzalkonium chloride (BAC), benzethonium chloride (BZT), dimethyldioctadecylammonium chloride, and dioctadecyldimethylammonium bromide (DODAB), and combinations thereof.

In some embodiments, the oleophobic surface coating on the oven comprises a thickness between 0.01 micrometers to 100 micrometers. In some instances, the oleophobic surface coating on the oven comprises a water contact angle between 100 degrees and 150 degrees as tested by ASTM D7490-13 using distilled water. In some embodiments, the oleophobic surface coating on the oven comprises, or can be produced using, an organofunctional silane system. In other examples, the oleophobic surface coating on the oven comprises, or can be producing using, an epoxysilane.

In other examples, the oleophobic surface coating on the oven is produced by contacting an oven surface with a wipe comprising a carrier material and a coating material retained by the carrier material to transfer at least some of the retained coating material from the wipe to the contacted surface, and heat curing the transferred coating material on the contacted surface to provide the oleophobic surface coating that provides the easy-to-clean performance in the cleanability test for at least ten cycles and does not off-gas any hazardous compounds when the surface comprising the oleophobic surface coating is heated to a temperature of 350 degree Celsius.

In some configurations, the exact configuration of the oven that comprises an oleophobic surface coating may vary. For example, the oven may comprise an exposed lower heating element in the cooking cavity. The oleophobic surface coating can be present on a surface below the exposed lower heating element. In other configurations, the oven comprises a panel covering a lower heating element in the cooking cavity. The oleophobic surface coating can be present on a top surface of the panel.

In other embodiments, the oven can be configured as one or more of a combination oven (combi-oven), a recreational vehicle oven, a microwave oven, a semi-conductor processing oven, or a residential oven comprising a cooktop, wherein the residential oven is configured to heat the cooking cavity to a temperature up to about 290 degrees Celsius. An optional cooktop may be present in combination with the oven to provide a stove or range. If desired, an oleophobic surface coating can be present on a surface of the cooktop. For example, the oleophobic surface coating on the surface of the cooktop can provide easy-to-clean performance in a cleanability test for at least one cycle and does not off gas any halogenated compounds when the cooktop surface comprising the oleophobic surface coating is heated. If desired, the surface coating on the cooktop may provide easy-to-clean performance in a cleanability test for at least five cycles or at least ten cycles.

In some examples, the surface coatings can be present on a combination oven. Combination ovens or combi-ovens are cooking appliances/device typically found in commercial kitchens, professional catering and/or food service operations. Combi-ovens can provide dry (convection) and moist (steam) heat, and are capable of shifting between them automatically during the cooking process. Combi-ovens typically provide steam using one of two systems: Boiler or cauldron systems produce steam within a steam generator located outside the cooking chamber, steam is then fed into the cooking chamber as needed; or injection systems which generate steam directly inside the cooking chamber by spritzing water onto the heating element within the core of the rotating ventilator, or onto a heat exchanger. Referring to FIG. 1A, a combination oven 10 is shown that comprises a housing 12 comprising a cooking cavity 14 within the housing 12. The internal surfaces of the cooking cavity 14 may be referred to in certain instances below as a “substrate.” Sidewalls of the cooking cavity 14 may provide for rack supports 11 holding conventional cooking racks for supporting pans or trays of food. The cooking cavity 14 may be accessed through a door 16 connected by a hinge at one vertical side of the cooking cavity 14. The door 16 may close over the cooking cavity 14 during the cooking operation as held by a latch assembly 15 (visible on the door 16 only). In the closed position, the door 16 may substantially seal against the cooking cavity 14 by compressing a gasket 17 surrounding an opening of the cooking cavity 14 in the housing 12. At one side of the cooking cavity 14, the housing 12 may expose a control panel 23 accessible by a user standing in front of the oven 10. The control panel 23 may present conventional electronic controls such as switches, buttons, a touchscreen or the like that may receive oven control data from the user as will be described below.

Referring now to FIG. 1B, a motor-driven convection fan 18 is typically positioned within the housing 12 of the oven 10 and is in communication with the cooking cavity 14 to direct a stream of air across a heater element 20 into the cooking cavity 14. The heater element 20 may surround the convection fan 18 and may be an electric resistance element or a heat exchanger tube receiving heat from a gas flame or the like. A bottom wall 31 of the cooking cavity 14 may provide a drainpipe 25 extending downwardly from the bottom wall 31 to a water trap 30 positioned beneath the bottom wall 31. The drainpipe 25 may extend vertically (as shown) or may extend horizontally for a short distance before or after it is received within the water trap 30. As noted in more detail below, the bottom wall 31 or side walls, top walls or all of them within the cavity 14 may comprise one or more of the surface coatings described herein. In certain configurations, the drainpipe 25 allows steam and water vapor to enter the water trap 30 from the otherwise sealed cooking cavity 14, the water trap 30 providing a generally enclosed box whose upstanding sidewalls retain a pool of water having a water level 36. The lower end of the drainpipe 28 passes downward through the water level 36 stopping above its bottom wall 33. An exit port 38 to the side of the drainpipe 28 provides a passageway out of the water trap 30 from a point above the water level 36. While not wishing to be bound by this configuration, the water trap 30 seals the cooking cavity 14 from the free flow of air into or out of the cooking cavity 14 unless a pressure difference exists sufficient to displace the water within the drainpipe 25 so as to allow gases to bubble through water to pass between the drainpipe 24 and exit port 38. In this respect, the water trap 30 provides an excess pressure relief valve. An optional boiler 22 may be located to the side of the cooking cavity 14, typically opposite the convection fan 18. Generally the boiler provides steam 24 into the cooking cavity 14 through a steam port 26 positioned near the top of the boiler 22. Ovens of this type are commercially available, for example, from Alto-Shaam Inc. of Menomonee Falls, Wis. and are described generally in U.S. Pat. No. 6,188,045 “Combination Oven with Three Stage Water Atomizer”, and the above-referenced patent is hereby incorporated by reference.

Referring again to FIG. 1B and also to FIG. 1C, a lower portion of the boiler 22 may admit electrical heaters 40 to heat the water within the boiler 22 to boiling point to generate steam. Inwardly extending baffles 42 on the opposed inner walls of the boiler 22 are positioned to prevent steam bubbles generated at the heaters 40 from carrying water out of the port 26 while nevertheless allowing steam 24 to pass upward and out of that port 26. The outer surfaces of the boiler 22 and the cooking cavity 14 are covered with an insulating material 44 such as fiberglass to minimize heat loss from these elements out of the housing 12. If desired, the surfaces of the boiler 22 may also comprise one or more of the coatings described herein to reduce corrosion, fouling, etc. within the boiler 22. An electric water valve 46 may communicate with a source of water 48, for example, filters attached to a water main or the like, so that the electric water valve 46 may control water flow into the boiler 22 through an entrance pipe positioned near the top of the boiler chamber 22. The entrance pipe may be positioned so as to not discharge water through the port 26 (when the first electric water valve 46 is open) but nevertheless to permit water to spray down the inside of the boiler 22 above the normal level of water within the boiler 22. A second electric water valve may communicate with an exit pipe positioned at the bottom of the boiler 22 to conduct water (when the second electric water valve is open) from the boiler 22 to a drainpipe that may lead to a building water drain or the like. An upper and lower water sensor 58 and 60 may extend through one wall of the boiler 22 into the volume of the boiler 22 to detect the presence of water at first and second vertically displaced locations about a desired water level and hence to allow determination of a water height 62 within the boiler chamber to above, below, or between the first and second water sensors 58 and 60.

Referring again to FIG. 1B, each of valve 46 and 52, heaters 40, and water sensors 58 and 60 may be in electrical communication with a controller or processor (not shown) that also provides electrical connections to other controllable elements of the oven 10, for example, including a motor driving the fan 18, the heater elements 20 and the motor. The controller may provide for an electronic computer and an electronic memory holding within it a stored program to control these various electrical components.

In certain embodiments, at least one surface of the oven shown in FIGS. 1A-3 may comprise an oleophobic coating as described herein. For example, a coating can be present on an oven surface of the ovens shown in FIG. 1A-3 which is generally considered an oleophobic coating. Oleophobic coatings have a water contact angle of more than 90 degrees when using grape seed oil as measured by the ASTM D7490-13 standard. In other examples, a coating can be present an oven surface of the ovens shown in FIG. 1A-3 that does not result in any off-gassing of hazardous halogenated materials, e.g., fluorinated materials, when the oven surface including the coating is heated to a temperature of about 350 degrees Celsius. For example, the coating can be present on an oven surface of the ovens shown in FIG. 1A-3 to enhance cleanability of the oven surface. In some instances, debris, residue or other materials may end up on the oven surface during or after heating of the surface. The presence of the coating permits removal of the debris or residue in an easy manner. Where the coating does not provide any off-gassing of halogenated materials, the coating may also be oleophobic as noted herein. In other examples, the coating an oven surface of the ovens shown in FIG. 1A-3 may provide “easy-to-clean” performance in a cleanability test as described herein.

In some examples, the oven can be configured as a residential oven similar to the one shown in FIG. 2. The oven 80 comprises an oven cavity 82, a door (not shown) to seal the oven cavity 82 so it retains heat, an optional cooktop or range surface 84 comprising one or more burners, and oven controls 86. A bottom heating element 83 is shown, and the oven 80 typically also comprises an upper heating element (not shown). A surface coating as described herein can be present on one or more surfaces of the oven cavity 82 and can be disposed prior to manufacture of the oven cavity 82, subsequent to manufacture of the oven cavity 82 or both. For example, a surface coating may be disposed on generally planar sheets of steel, stainless steel or other materials and the coated sheets can be formed into the oven cavity 82. In other instances, steel, stainless or other materials can first be formed into the oven cavity 82, and then the surface coating material may be disposed on one or more surfaces of the oven cavity 82, e.g., using a wipe, applicator or other means. In some examples, the heating element 83 may be exposed (as shown in FIG. 2), whereas in other instances the heating element 83 may be covered by a panel or liner positioned above the heating element 82. In such cases, the panel or liner may comprise a surface coating as described herein. Where burners are present, the burners may be one or more of electric burners, radiant burners, induction burners, gas burners or other burners.

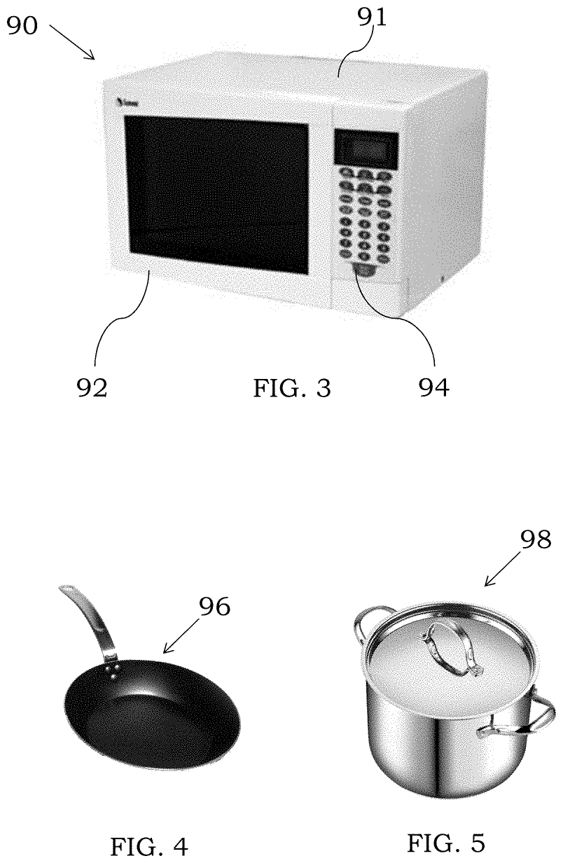

In certain examples, the coatings described herein can be present on one or more surface of a microwave oven. Referring to FIG. 3, a microwave oven 90 is shown that comprises a housing 91 which contains a microwave oven cavity behind a door 92. The oven 90 comprises a keypad 94 which can be used to control the oven 90. At least one surface within the microwave oven cavity may comprise an oleophobic coating as described herein. For example, a coating can be present on a microwave oven surface which is generally considered an oleophobic coating.

Oleophobic coatings can have, for example, a contact angle of more than 90 degrees when using grape seed oil as measured by the ASTM D7490-13 standard. In other examples, a coating can be present a microwave oven surface that does not result in any off-gassing of hazardous halogenated materials, e.g., fluorinated materials, when the objects within the microwave oven are heated. For example, the coating can be present on a microwave oven surface to enhance cleanability of the oven surface. In some instances, debris, residue or other materials may end up on the microwave oven surface during or after heating of the surface. The presence of the coating permits removal of the debris or residue in an easy manner. Where the coating does not provide any off-gassing of halogenated materials, the coating may also be oleophobic as noted herein.

In certain embodiments, the coatings of the combi-ovens and ovens may be an aqueous based coating that can be applied by spraying, wiping, brushing, etc. optionally using a wipe and/or applicator as described in more detail below. For example, one or more coating materials can be applied directly on enamelized carbon steel, stainless steel or any other material that can provide good corrosion resistance. Further, flat sheets of material can be coated and then formed into an oven cavity after coating rather than needing to first form the oven cavity and then applying the coating. The coating may generally comprise one or more of the properties described herein.

In other instances, the oleophobic surface coating can be present on a cooking article such as a pot, pan, or other surfaces that can be thermally coupled to an item to be heated. For example, an article can comprise a surface, e.g., a cooking surface, configured to transfer heat to an object thermally coupled to the surface, the surface comprising an oleophobic surface coating that provides easy-to-clean performance in a cleanability test for at least ten cycles and does not off-gas any hazardous compounds when the oleophobic surface coating is heated to a temperature of 350 degree Celsius. In some instances, the surface comprises a metal, a plastic, a glass or a ceramic. In other examples, the surface comprises a ceramic and the ceramic comprises a vitreous enamel. In some embodiments, the article may be a cooking pan 96 (as shown in FIG. 4), a cooking pot 98 (as shown in FIG. 5) or other vessels such as crockpots, wafer boats, or other devices which can receive a liquid or solid material to heat the liquid or solid material.

In some examples, the oleophobic surface coating on the article can be produced using one or more of parylene, organofunctional silanes, fluorinated organofunctional silane, fluorinated organofunctional siloxane, organo-functional oligomeric siloxane, organofunctional resins, hybrid inorganic organofunctional resins, low-surface-energy resins, organofunctional polyhedral oligomeric silsesquioxane (POSS), hybrid inorganic organofunctional POSS resins, fluorinated oligomeric polysiloxane, organofunctional oligomeric poly siloxane, hybrid inorganic organofunctional oligomeric poly siloxane, fluorinated organofunctional silicone copolymers, organofunctional silicone polymers, hybrid inorganic organofunctional silicone polymers, organofunctional silicone copolymers, hybrid inorganic organofunctional silicone copolymers, fluorinated polyhedral oligomeric silsesquioxane (FPOSS), non-volatile linear and branched alkanes, alkenes and alkynes; esters of linear and branched alkanes, alkenes and alkynes, perfluorinated organic material, silane coupling agents, fluorinated alkylsiloxane, organofunctional resins, hybrid inorganic organofunctional resins, silicone polymers, surface-modified inorganic particles, fluorinated alkylsilane, fluorinated based organo-functional silane, fluorinated based organo-functional siloxane, polydimethylsiloxane, fluorinated organo-functional oligomeric siloxane, polymer blends, aqueous preparation of an organofunctional silane system, organofunctional polysiloxane, silane based sol-gel system, fluoroalkysilane, hydrolyzable inorganic ethoxysilyl groups, sol-gel systems, silane system, functionalized silanol groups, other similar groups, aqueous, and alcohol-free products of epoxysilanes.

In other instances, the oleophobic surface coating on the article can be produced using a material comprising carbon, fluorine, and silicon, and wherein the oleophobic surface coating comprises a crosslinked mesh on the surface. In other examples, the oleophobic surface coating on the article can covalently bond to the surface. In some examples, the oleophobic surface coating on the article can be between 0.01 micrometers to 100 micrometer. In some embodiments, the oleophobic surface coating comprises a mesh with a surface roughness between 0.5 nm to 50 nm.

In some examples, the oleophobic surface coating on the article comprises, or can be produced using, at least particle comprising silica (SiO2) particles, platinum oxide (Pt2O), alumina particles (Al2O3), silicon carbide (SiC), single wall carbon nanotubes (SWCNTs), multi-wall carbon nanotubes (MWCNTs), diatomaceous earth (DE), boron nitride (BN), titanium oxide (TiO2), mixture of titanium/silica oxide (TiO2/SiO2, titanium inner core/silicon outer surface), ceramic particles, thermo-chromic metal oxides, diamond, particles formed by differential etching of spinodal decomposed glass, molybdenum disulfide (MoS2), boron nitride (BN), sulfides, selenides and tellurides (chalcogenides) of molybdenum, tungsten, niobium, tantalum, and titanium (eg. WS2, WSe2, MoSe2, TaSe2, TiTe2), monochalcenides (GaS, GaSe, SnSe), chlorides of cadmium, cobalt, lead, cerium, zirconium (eg. CdCl2, CoC12, PbCl2, CeF3, PbI2), borates (eg. Na2B4O7) sulfates (eg. Ag2SO4), black carbon, carbon black, engineered carbon-based nanomaterials, e.g., carbon nanotubes, fullerenes, and graphene. In other examples, the particles are functionalized with a compound selected from the group consisting of an organofunctional silane, parylene, fluorinated alkylsilane, fluorinated alkylsiloxane, fluorinated based organo-functional silane, fluorinated based organo-functional siloxane, organofunctional resins, hybrid inorganic organofunctional resins, silicone polymers, polydimethylsiloxane, organofunctional silicone polymers, organofunctional silicone copolymers, fluorinated organofunctional silicone copolymers, organo-functional oligomeric siloxane, fluorinated organo-functional oligomeric siloxane, organofunctional polyhedral oligomeric silsesquioxane (POSS), fluorinated polyhedral oligomeric silsesquioxane (FPOSS), fluorinated oligomeric polysiloxane, organofunctional oligomeric poly siloxane, fluorinated organofunctional silicone copolymers, organofunctional silicone polymers, hybrid inorganic organofunctional silicone polymers, organofunctional silicone copolymers, hybrid inorganic organofunctional silicone copolymers, non-volatile linear and branched alkanes, alkenes and alkynes; esters of linear and branched alkanes, alkenes and alkynes, perfluorinated organic material, silane coupling agents, organofunctional silane systems, and combinations thereof.

In some embodiments, the coating material used to produce the surface coating on the article provides proper dispersion on the surface, wherein proper dispersion is identified by a contact angle of less than fifty degrees between a droplet of the coating material and the surface. In some embodiments, the proper dispersion on the surface can be provided without any cleaning or pre-treatment of the surface.

In some configurations, the article may comprise a surface that is a cooking surface comprising one or more of a gas burner, an electric burner, a radiant burner, a ceramic burner and an induction burner. For example, the article can be configured as an electric stove comprising an oven and a cooktop surface, wherein the oleophobic coating is present on the cooktop surface. If desired, an oleophobic surface coating can also be present on a surface of the oven, wherein the oleophobic surface coating on the surface of the oven provides easy-to-clean performance in a cleanability test for at least ten cycles and does not off-gas any hazardous compounds when the oleophobic surface coating is heated to a temperature of 350 degree Celsius.

In other configurations, the article is configured a gas stove comprising an oven and a cooktop surface, wherein the oleophobic coating is present on the cooktop surface. In some instances, the gas stove further comprises an oleophobic surface coating on a surface of the oven, wherein the oleophobic surface coating on the surface of the oven provides easy-to-clean performance in a cleanability test for at least ten cycles and does not off-gas any hazardous compounds when the oleophobic surface coating is heated to a temperature of 350 degree Celsius.

In some examples, the article is configured a recreational vehicle stove comprising an oven and a cooktop surface, wherein the oleophobic coating is present on the cooktop surface. For example, the recreational vehicle can comprise an oleophobic surface coating on a surface of the oven, wherein the oleophobic surface coating on the surface of the oven provides easy-to-clean performance in a cleanability test for at least ten cycles and does not off-gas any hazardous compounds when the oleophobic surface coating is heated to a temperature of 350 degree Celsius.

Wipe Materials

In certain embodiments, the wipes described herein may comprise a carrier material that retains the material(s), at least to some degree, that provides the coating on a surface. The retention of the carrier material is not so high or the amount of the material(s) is not so small that the material(s) used to provide the coating cannot be transferred to a surface. For example, the carrier material can be sprayed with the material(s) that provides the coating, can be soaked in the material(s) that provides the coating, dipped into the material(s) that provides the coating or otherwise loaded with the material(s) that provides the coating.

In certain embodiments, the wipe can comprise any woven or nonwoven web material or other suitable materials that can retain the coating materials to at least some degree. The wipe may comprise a blend of natural pulp and/or man-made fibers. The pulp component of the wipe can be include, but is not limited to, natural cellulosic fibers, cotton, wood fibers, softwood paper making pulp, such as spruce, hemlock, cedar and pine, hardwood pulp and non-wood pulp, such as hemp and sisal. In addition, the nonwoven web material can include, but is not limited to, wood pulp and man-made fibers. Examples of man-made fibers include, but are not limited to, cellulosic fibers, cellulose acetate, polyester, nylon and polypropylene fibers. The wipe may comprise papers, plastics or other polymers and may optionally comprise gels or other materials which can be used to assist in retention of the material(s) used to provide the coating.

In other instances, the wipe itself may be “dry” and may not comprise a material to be coated but instead can be used to spread the material to be coated onto or around a surface. For example, the material(s) used to provide the coating may be sprayed onto a surface, and the wipe can then be used to spread the sprayed material around the surface. In other instances, the wipe may also comprise a material(s) used to provide a coating and be used to spread material(s) that has been sprayed onto a surface.

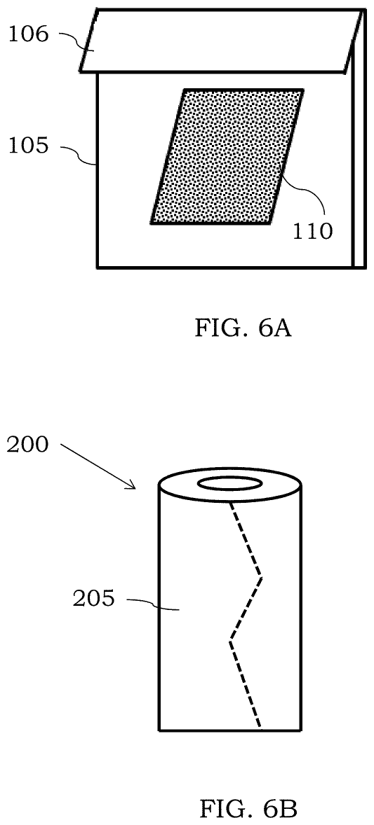

In some examples, the wipe may be individually packaged in a pouch or other packaging. Where the wipe comprises a material(s) that provides a coating, the packaging used desirably prevents the wipe from drying out. This configuration permits reuse of the wipe multiple times. An illustration of a wipe 110 in a package 105 is shown in FIG. 6A. The package 105 may comprise a flap 106 to permit removal of the wipe 110. After use, the wipe 110 can be returned to the package 105 for reuse or may be disposed of. If desired, excess material used to provide the coating can be present in the package 105 to replenish the material removed from the wipe 110 during the coating process. However, presence of excess material(s) is the package 105 is not required for multiple use of the wipe.

In certain examples, the wipe may instead be present as a single wipe in a roll of wipes. The whole roll of wipes is placed in a package. The packaging used desirably prevents the roll of wipes from drying out. An illustration is shown in FIG. 6B where a roll of wipes 200 comprises a plurality of wipes coupled to each other. For example, wipe 205 is present in the roll of wipes 200 and can be removed by tearing the wipe away from the roll. In some examples, perforations or other structures may exist in the carrier material to permit easy removal of an individual wipe from the roll. The dimensions of each wipe in the roll 200 can be the same or can be different. Further, perforation spacing may be varied to permit a user to select the width or size of the particular wipe to be used. The roll of wipes 200 can be placed in an optional package (not shown) to keep the wipes from drying out.

In certain embodiments, the wipes may include other materials including colorants, markings or other materials. In some examples, the wipes are white in color, whereas in other instances the wipes may comprise a high visibility material to permit easier viewing of the wipes in darker environments. The wipes can be textured, smooth or include a desired density of pores or roughness. The wipes can be shaped differently including square, rectangular, circular, elliptical or other geometric shapes. The wipes can also be sized differently. For example, the wipe can be sized and arranged as an insert which can occupy substantially all of a lower surface in an item to be coated, e.g., can occupy a lower surface of an oven. In other examples, the wipe can be sized and arranged to be placed on top of a surface to be coated, and the wipe can be pressed to transfer at least some of the material(s) to the surface. The wipe can remain in place during curing or drying of the coating or may be removed prior to curing or drying of the coating.

Materials Used to Produce Coatings

In some embodiments, the material(s) used to produce the coating may provide a coating with one or more of the following properties: an oleophobic coating, a coating that does not off-gas halogens such as fluorine upon heating up to 350 degrees Celsius and a coating with easy-to-clean performance. The exact material or materials used to provide the coatings can vary. In some embodiments, the materials used to provide the coating may be present in a wipe, a spray, a liquid, an aerosol or take other forms to permit an end-user to transfer at least some of the material to the surface to be coated. One problem with conventional coatings is their durability. After end users buy the coated product (for example an oven), the coating may be damaged due to mechanical forces (for example abrasion due to the use of a sponge), chemical exposure (for example, due to the oil that comes from burnt food or the cleaning agent used during cleaning). Thermal cycling may also cause coating destruction. When the original manufacturer applies the coating on the surface, it usually goes through a sophisticated process like roughening or a high baking temperature. Therefore, reapplying conventional coatings in working conditions (for example, in people's houses) is not realistic or possible. In contrast, the coatings described herein can be easily reapplied and cured in a domestic or commercial setting. For example, the coatings can be reapplied using wipes or brushes. The material can also be sprayed on the surface and then spread on the surface using a wipe or a brush. Reapplication of the coating can retrieve the easy-to-clean properties of the coating. In some examples, as noted herein a wipe soaked in the coating material(s) or used to apply the coating, can be used to reapply the coating. In some instances, a first wipe is used to clean or pretreat the surface (cleaning wipe), whereas in other examples no cleaning or pretreatment is performed. Where a pre-coating wipe is used for cleaning the surface, this wipe can be replaced with sprays and cleaning agents if desired. A second wipe or other applicator such as a spray can be used to then apply the coating material to the cleaned surface. Once applied, the material can be heat cured to provide a resulting coating on the surface.

In some examples, the material(s) used to provide the coating may comprise POLYFLON PTFE, NEOFLON dispersion, Unidyne Multi-Series™ such as Unidyne TG-5545 and Unidyne TG-5601, DAI-EL Latex fluoroelastomer SILRES® BS 39, TES 40 WN, Sureco, AsahiGuard E-SERIES™, polytetrafluorethylene (PTFE), parylene, organofunctional silanes, fluorinated organofunctional silane, fluorinated organofunctional siloxane, organo-functional oligomeric siloxane, organofunctional resins, hybrid inorganic organofunctional resins, low-surface-energy resins, organofunctional polyhedral oligomeric silsesquioxane (POSS), hybrid inorganic organofunctional POSS resins, fluorinated oligomeric polysiloxane, organofunctional oligomeric poly siloxane, hybrid inorganic organofunctional oligomeric poly siloxane, fluorinated organofunctional silicone copolymers, organofunctional silicone polymers, hybrid inorganic organofunctional silicone polymers, organofunctional silicone copolymers, hybrid inorganic organofunctional silicone copolymers, fluorinated polyhedral oligomeric silsesquioxane (FPOSS), non-volatile linear and branched alkanes, alkenes and alkynes; esters of linear and branched alkanes, alkenes and alkynes, perfluorinated organic material, silane coupling agents, fluorinated alkylsiloxane, organofunctional resins, hybrid inorganic organofunctional resins, silicone polymers, surface-modified inorganic particles, fluorinated alkylsilane, fluorinated based organo-functional silane, fluorinated based organo-functional siloxane, polydimethylsiloxane, fluorinated organo-functional oligomeric siloxane, polymer blends, aqueous preparation of an organofunctional silane system, organofunctional polysiloxane, silane based sol-gel system, fluoroalkysilane, hydrolyzable inorganic ethoxysilyl groups, sol-gel systems, silane system, functionalized silanol groups, other similar groups, aqueous, alcohol-free products of epoxysilanes, or any combination thereof.

In certain embodiments, the materials used to provide the coatings may comprise a silane system such as, for example, silane compounds comprising alkoxysilanes or organoalkoxysilanes such as, for example, tris(triethoxysilylpropyl)amine (tris-AMEO). In certain examples, the surface coating may be produced using one or more silane systems comprising trisamino-functional alkoxysilanes, such as tris(triethoxysilane)-amine or tris(trimethoxysilane)amine, alkoxysilanes or organoalkoxysilane systems from the group of n-propyltriethoxysilane, n-propyltrimethoxysilane (PTMO), 3-glycidyloxypropyltriethoxysilane (GLYEO), 3-glycidyloxypropyltrimethoxysilane (GLYMO), 3-aminopropyltriethoxysilane (AMEO), 3-aminopropyltrimethoxysilane (AMMO), methacryloxypropyltriethoxysilane (MEEO), methacryloxypropyltrimethoxysilane (MEMO), N-(n-butyl)-3-aminopropyltriethoxysilane, vinyltrimethoxysilane (VTMO), N-(n-butyl)-3-aminopropyltrimethoxysilane (Dynasylan® 1189), 3-mercaptopropyltrimethoxysilane (MTMO), 3-mercaptopropyltriethoxysilane (MTEO), N-2-aminoethyl-3-aminopropyltrimethoxysilanes (DAMO), polyethylene glycol-functionalized alkoxysilanes, tetraethoxysilane (Dynasylan A), tetramethoxysilane (Dynasylan M), methyltriethoxysilane (MTES), methyltrimethoxysilane (MTMS), bis(triethoxysilylpropyl)tetrasulphane (Si 69), bis(triethoxysilylpropyl)-disulphane (Si 266), bis(trimethoxysilylpropyl)disulphane, bis(trimethoxysilylpropyl)tetrasulphane, vinyltriethoxysilane (VTEO), 1-aminomethyltriethoxysilyne, 1-aminomethyltrimethoxysilyne, 1-methacryloxymethyltrimethoxysilane, 1-methacryloxymethyltriethoxysilane, 1-mercaptomethyltriethoxysilane, 1-mercaptomethyltrimethoxysilane, isobutyltrimethoxysilane, isobutyltriethoxysilane, octyltriethoxysilane (Dynasylan® OTEO), octyltrimethoxysilane, hexadecyltriethoxysilane, hexadecyltrimethoxysilane, phenyltrimethoxysilane, phenyltriethoxysilane, 2-aminoethyl-3-aminopropylmethyldimethoxysilanes, 2-aminoethyl-3-aminopropylmethyldiethoxysilanes, ureidopropyltrimethoxysilane, ureidopropyltriethoxysilane, tridecafluorooctyltriethoxysilane, tridecafluorooctyltrimethoxysilane, organoalkoxysilylalkylsuccinic anhydride such as triethoxysilylpropylsuccinic anhydride, trimethoxysilylpropylsuccinic anhydride, methyldiethoxysilylpropylsuccinic anhydride, methyldimethoxysilylpropylsuccinic anhydride, dimethylethoxysilylpropylsuccinic anhydride, dimethylmethoxysilylpropylsuccinic anhydride—to name just a few examples, Dynasylan® 1151 (alcohol-free aminosilane hydrolysis product), Dynasylan® HS 2627 (alcohol-free cocondensate of aminosilane and alkylsilane), Dynasylan® HS 2776 (aqueous, alcohol-free cocondensate of diaminosilane and alkylsilane), Dynasylan® HS 2909 (aqueous, alcohol-free cocondensate of aminosilane and alkylsilane), Dynasylan® HS 2926 (aqueous, alcohol-free product based on epoxysilane), Dynasylan® SIVO materials (e.g., aqueous, alcohol-free products of epoxysilanes), bis(triethoxysilane)amine and/or bis(trimethoxysilane)amine.

In other instances, the materials used to provide the coatings may be produced using one or more silane systems based on co-condensates of trisamino-functional alkoxysilanes (e.g., such as tris(triethoxysilane)-amine or tris(trimethoxysilane)amine) with one or more of alkoxysilanes or organoalkoxysilane systems from the group of n-propyltriethoxysilane, n-propyltrimethoxysilane (PTMO), 3-glycidyloxypropyltriethoxysilane (GLYEO), 3-glycidyloxypropyltrimethoxysilane (GLYMO), 3-aminopropyltriethoxysilane (AMEO), 3-aminopropyltrimethoxysilane (AMMO), methacryloxypropyltriethoxysilane (MEEO), methacryloxypropyltrimethoxysilane (MEMO), N-(n-butyl)-3-aminopropyltriethoxysilane, vinyltrimethoxysilane (VTMO), N-(n-butyl)-3-aminopropyltrimethoxysilane (Dynasylan® 1189), 3-mercaptopropyltrimethoxysilane (MTMO), 3-mercaptopropyltriethoxysilane (MTEO), N-2-aminoethyl-3-aminopropyltrimethoxysilanes (DAMO), polyethylene glycol-functionalized alkoxysilanes, tetraethoxysilane (Dynasylan A), tetramethoxysilane (Dynasylan M), methyltriethoxysilane (MTES), methyltrimethoxysilane (MTMS), bis(triethoxysilylpropyl)tetrasulphane (Si 69), bis(triethoxysilylpropyl)-disulphane (Si 266), bis(trimethoxysilylpropyl)disulphane, bis(trimethoxysilylpropyl)tetrasulphane, vinyltriethoxysilane (VTEO), 1-aminomethyltriethoxysilyne, 1-aminomethyltrimethoxysilyne, 1-methacryloxymethyltrimethoxysilane, 1-methacryloxymethyltriethoxysilane, 1-mercaptomethyltriethoxysilane, 1-mercaptomethyltrimethoxysilane, isobutyltrimethoxysilane, isobutyltriethoxysilane, octyltriethoxysilane (Dynasylan® OTEO), octyltrimethoxysilane, hexadecyltriethoxysilane, hexadecyltrimethoxysilane, phenyltrimethoxysilane, phenyltriethoxysilane, 2-aminoethyl-3-aminopropylmethyldimethoxysilanes, 2-aminoethyl-3-aminopropylmethyldiethoxysilanes, ureidopropyltrimethoxysilane, ureidopropyltriethoxysilane, tridecafluorooctyltriethoxysilane, tridecafluorooctyltrimethoxysilane, organoalkoxysilylalkylsuccinic anhydride such as triethoxysilylpropylsuccinic anhydride, trimethoxysilylpropylsuccinic anhydride, methyldiethoxysilylpropylsuccinic anhydride, methyldimethoxysilylpropylsuccinic anhydride, dimethylethoxysilylpropylsuccinic anhydride, dimethylmethoxysilylpropylsuccinic anhydride, or Dynasylan® 1151 (alcohol-free aminosilane hydrolysis product), Dynasylan® HS 2627 (alcohol-free cocondensate of aminosilane and alkylsilane), Dynasylan® HS 2776 (aqueous, alcohol-free cocondensate of diaminosilane and alkylsilane), Dynasylan® HS 2909 (aqueous, alcohol-free cocondensate of aminosilane and alkylsilane), Dynasylan® HS 2926 (aqueous, alcohol-free product based on epoxysilane), Dynasylan® SIVO materials (e.g., aqueous, alcohol-free products of epoxysilanes), bis(triethoxysilane)amine and/or bis(trimethoxysilane)amine. Additional co-condensates can be prepared, for example, from tris-AMEO/tris-AMMO and PTMO or with GLYMO or from tris-AMEO/tris-AMMO and AMEO, bis-AMEO, MEMO, VTMO, VTEO, Dynasylan® 1189, mercaptoalkylsilane, DAMO, TRIAMO, Dynasylan® 4144, Dynasylan A, alkyltrialkoxysilane, bis(trialkoxysilylalkyl)-polysulphane (for example Si69), bis(trialkoxysilylalkyl)disulphane (for example Si 266).

In certain instances, the materials used to provide the surface coating can be one or more of tris(trialkoxysilylalkyl)amine, tris-N,N′-(trialkoxysilylalkyl)alkylenediamine and/or tris-N,N′-(trialkoxysilylalkyl)dialkylenetriamine, especially tris(triethoxysilylpropyl)amine (N[(CH2)3Si(OC2H5)3]3, tris-AMEO), tris(trimethoxysilylpropyl)amine (N[(CH2)3Si(OCH3)3]3, tris-AMMO), tris-DAMO (N[(CH2)2NH(CH2)3Si(OCH3)3]3 and/or tris-TRIAMO (N[(CH2)2NH(CH2)2NH(CH2)3Si(OCH3)3]3) In other instances, the surface coating can be produced using one or more of .bis(trialkoxysilylalkyl)amine, bis-N,N′-(trialkoxysilylalkyl)alkylenediamine and/or bis-N,N′-(trialkoxysilylalkyl)dialkylenetriamine, especially bis(triethoxysilylpropyl)amine ((H5C2O)3Si(CH2)3NH(CH2)3Si(OC2H5)3, bis-AMEO), bis(trimethoxysilylpropyl)amine ((H3CO)3Si(CH2)3NH(CH2)3Si(OCH3)3, bis-AMMO), bis-DAMO ((H3CO)3Si(CH2)3NH(CH2)2NH(CH2)3Si(OCH3)3) and/or bis-TRIAMO ((H3CO)3Si(CH2)3NH(CH2)2NH(CH2)2NH(CH2)3Si(OCH3)3), bis(diethoxymethylsilylpropyl)amine, bis(dimethoxymethylsilylpropyl)amine, bis(triethoxysilylmethyl)amine, bis(trimethoxysilylmethyl)amine, bis(diethoxymethylsilylmethyl)amine, bis(dimethoxymethylsilylmethyl)amine, (H3CO)2(CH3)Si(CH2)3NH(CH2)2NH(CH2)3Si(OCH3)2(CH3) and/or (H3CO)3(CH3)Si(CH2)3NH(CH2)2NH(CH2)2NH(CH2)3Si(OCH3)2(CH3), particular preference being given to bis(triethoxysilylpropyl)amine ((H5C2O)3Si(CH2)3NH(CH2)3Si(OC2H5)3, bis-AMEO). In additional instances, the surface coating can be producing using one or more of aminopropyltrimethoxysilane (H2N(CH2)3Si(OCH3)3, AMMO), aminopropyltriethoxysilane (H2N(CH2)3Si(OC2H5)3, AMEO), diaminoethylene-3-propyltrimethoxysilane (H2N(CH2)2NH(CH2)3Si(OCH3)3, DAMO), triaminodiethylene-3-propyltrimethoxysilane (H2N(CH2)2NH(CH2)2NH(CH2)3Si(OCH3)3 (TRIAMO), aminopropylmethyldiethoxysilane, aminopropylmethyldimethoxysilane, 2-aminoethyltrimethoxysilane, 2-aminoethylmethyldimethoxysilane, 2-aminoethylphenyldimethoxysilane, 2-aminoethyltriethoxysilane, 2-aminoethylmethyldiethoxysilane, 2-aminoethyltriethoxysilane, (2-aminoethylamino)ethyltriethoxysilane, 6-amino-n-hexyltriethoxysilane, 6-amino-n-hexyltrimethoxysilane, 6-amino-n-hexylmethyldimethoxysilane, and especially 3-amino-n-propyltrimethoxysilane, 3-amino-n-propylmethyldimethoxysilane, 3-amino-n-propyltriethoxysilane, 3-amino-n-propylmethyldiethoxysilane, 1-aminomethyltriethoxysilane, 1-aminomethylmethyldiethoxysilane, 1-aminomethyltrimethoxysilane, 1-aminomethylmethyldiethoxysilane, N-butyl-3-aminopropyltriethoxysilane, N-butyl-3-aminopropylmethyldiethoxysilane, N-butyl-3-aminopropyltrimethoxysilane, N-butyl-3-aminopropylmethyldimethoxysilane, N-butyl-1-aminomethyltriethoxysilane, N-butyl-1-aminomethylmethyldimethoxysilane, N-butyl-1-aminomethyltrimethoxysilane, N-butyl-1-aminomethylmethyltriethoxysilane, N-cyclohexyl-1-aminomethylmethyltriethoxysilane, N-cyclohexyl-1-aminomethylmethyltrimethoxysilane, N-phenyl-1-aminomethylmethyltriethoxysilane, N-phenyl-1-aminomethylmethyltrimethoxysilane, N-formyl-3-aminopropyltriethoxysilane, N-formyl-3-aminopropyltrimethoxysilane, N-formyl-1-aminomethylmethyldimethoxysilane and/or N-formyl-1-aminomethylmethyldiethoxysilane or mixtures thereof.

In further examples, the materials used to provide the coating can be one or more of propyltrimethoxysilane (PTMO), dimethyldimethoxysilane (DMDMO), dimethyldiethoxysilane, methyltriethoxysilane (MTES), propylmethyldimethoxysilane, propylmethyldiethoxysilane, n-octylmethyldimethoxysilane, n-hexylmethyldimethoxysilane, n-hexylmethyldiethoxysilane, propylmethyldiethoxysilane, propylmethyldiethoxysilane, propyltriethoxysilane, isobutyltrimethoxysilane, isobutyltriethoxysilane, octyltrimethoxysilane, octyltriethoxysilane, n-hexyltriethoxysilane, cyclohexyltriethoxysilane, n-propyl-tri-n-butoxysilane, n-propyltrimethoxysilane, n-propyltriethoxysilane, isobutyltriethoxysilane, hexadecyltriethoxysilane, hexadecyltrimethoxysilane, octadecyltriethoxysilane, octadecyltrimethoxysilane, octadecylmethyldiethoxysilane, octadecylmethyldimethoxysilane, hexadecylmethyldimethoxysilane and/or hexadecylmethyldiethoxysilane and mixtures of these silanes. In other instances, the material used to provide the surface coating can be one or more of 3-glycidoxypropyltrialkoxysilane, as the triethoxy- or trimethoxysilane; epoxycyclohexyltrialkoxysilane, as the triethoxy- or trimethoxysilane.

In some examples, the materials used to provide the coating can be an organofunctionalized alkoxysilane compound such as, for example, bis(triethoxysilylpropyl)disulphane (Si 266), bis(trimethoxysilylpropyl)disulphane, bis(triethoxysilylpropyl)tetrasulphane (Si 69), bis(trimethoxysilylpropyl)tetrasulphane, bis(triethoxysilylmethyl)disulphane, bis(trimethoxysilylmethyl)disulphane, bis(triethoxysilylpropyl)disulphane, bis(diethoxymethylsilylpropyl)disulphane, bis(dimethoxymethylsilylpropyl)disulphane, bis(dimethoxymethylsilylmethyl)disulphane, bis(diethoxymethylsilylmethyl)disulphane, bis(diethoxymethylsilylpropyl)tetrasulphane, bis(dimethoxymethylsilylpropyl)tetrasulphane, bis(dimethoxymethylsilylmethyl)-tetrasulphane, bis(diethoxymethylsilylmethyl)tetrasulphane, 3-mercaptopropyltrimethoxysilane, 3-mercaptopropyltriethoxysilane, tetramethoxysilane or tetraethoxysilane.

In some examples, the materials used to provide the coating can be produced one or more fluorosilane systems including, but not limited to, tridecafluoro-1,1,2,2-tetrahydrooctyl-1-trimethoxysilane, tridecafluoro-1,1,2,2-tetrahydrooctyl-1-triethoxysilane or corresponding mixtures comprising silanes derived therefrom, or 3,3,3-trifluoropropyltrimethoxysilane, 3,3,3-trifluoropropylmethyldimethoxysilane, 3,3,3-trifluoropropylmethyldimethoxysilane, 3,3,3-trifluoropropylcyclohexyldimethoxysilane, 3,3,3-trifluoropropylphenyldiethoxysilane, 3,3,3-trifluoropropyltriethoxysilane, 3,3,3,2,2-pentafluoropropylmethyldimethoxysilane, 3,3,3-trifluoropropyloxyethyltrimethoxysilane, 3,3,3-trifluoropropylmercaptoethyltrimethoxysilane, 3,3,3-trifluoropropyloxyethylmethyldimethoxysilane, and especially tridecafluoro-1,1,2,2-tetrahydrooctyltrimethoxysilane and tridecafluoro-1,1,2,2-tetrahydrooctyltriethoxysilane, and also acryloyloxypropyltrialkoxysilane, methacryloyloxypropyltrialkoxysilane, where the alkoxy radical can be replaced by methoxy, ethoxy or else propoxy radicals. Suitable compounds are likewise methacryloyloxymethyltriethoxysilane, methacryloyloxymethyltrimethoxysilane, methacryloyloxypropylmethyldiethoxysilane, methacryloyloxypropylmethyldimethoxysilane, methacryloyloxypropylmethyldiethoxysilane, methacryloyloxymethylmethyldiethoxysilane and/or methacryloyloxymethylmethyldimethoxysilane and/or mixtures of any of these compounds. As noted herein, where fluorinated materials are used, the fluorinated materials used do not produce any off-gassing when heated up to 350 degrees Celsius.

In certain examples, the materials used to provide the coatings can be produced by mixing a siloxane, organosiloxane, aminosiloxane, siloxane precursor, or aminosiloxane precursor (or combinations thereof) with water, and a catalyst to promote a sol-gel reaction to form a solution having particles. If desired, the sol-gel reaction can be performed without using any organic solvent. Chemical modification of the resulting particles can be performed, for example, by reacting a hydrophobic agent with the particles to provide surface-modified particles. If desired, a surfactant can be added to the surface-modified particles to provide a surface coating material that may be hydrophobic depending on the particular surface modifications performed. The siloxane precursor may comprise, for example, one or more —SiOR or —SiOH functional groups, wherein R is CₙH₂ₙ₊₁, and n is a positive integer. In some instances, R may comprise at least one fluoro group or at least one amino group or both. Examples for the siloxane precursor may be tetramethoxysilane (TMOS), tetrathoxysilane (TEOS), titanium tetraisopropoxide, titanium tetramethoxide, titanium tetraethoxide, titanium tetrabutoxide, aluminum tri-sec-butoxide, or zirconium n-butoxide and fluorinated derivatives of these precursors and amino derivatives of these precursors. The catalyst may be, for example, organic acid/base or inorganic acid/base, such as hydrochloric acid, sulfuric acid, nitric acid, acetic acid, potassium hydroxide, sodium hydroxide, ammonium, or the like. Where surface modification occurs, the surface modifying agent may comprise a siloxane, a fluorosiloxane, an aminosiloxane, an aminofluorosiloxane, a silane, a fluorosilane, an aminosilane, an aminofluorosilane, silicone, or combinations thereof. Examples of the fluorine-base surface modifying agents include, but are not limited to, fluorosilane, fluoroalkysilane, polytetrafluoroethylene (PTFE), polytrifluoroethylene, polyvinylfluroride, functional fluoroalkyl compound, 1H, 1H, 2H, 2H-perfluorodecyltriethoxysilane or combinations thereof. Where surfactant is present, the surfactant may be an anion surfactant, a cation surfactant, a combination of an anion surfactant and a cation surfactant, a combination of an anion surfactant and a non-ionic surfactant, a combination of anion surfactant and an amphoteric surfactant, or combinations thereof.

In some examples, the materials used to provide the coating may comprise particles. The particles may include, for example, silica (SiO2) particles, platinum oxide (Pt2O), alumina particles (Al2O3), silicon carbide (SiC), single wall carbon nanotubes (SWCNTs), multi-wall carbon nanotubes (MWCNTs), diatomaceous earth (DE), boron nitride (BN), titanium oxide (TiO2), mixture of titanium/silica oxide (TiO2/SiO2, titanium inner core/silicon outer surface), ceramic particles, thermo-chromic metal oxides, diamond, particles formed by differential etching of spinodal decomposed glass, molybdenum disulfide (MoS2), boron nitride (BN), sulfides, selenides and tellurides (chalcogenides) of molybdenum, tungsten, niobium, tantalum, and titanium (eg. WS2, WSe2, MoSe2, TaSe2, TiTe2), monochalcenides (GaS, GaSe, SnSe), chlorides of cadmium, cobalt, lead, cerium, zirconium (eg. CdCl2, CoC12, PbCl2, CeF3, PbI2), borates (eg. Na2B4O7) sulfates (eg. Ag2SO4), black carbon, carbon black, engineered carbon-based nanomaterials, e.g., carbon nanotubes, fullerenes, graphene and any combination thereof. As an instance, the materials used to provide the coating may comprise a combination of organofunctional silanes and functionalized particles such as functionalized silicon dioxide particles. If desired, particles may be present as or with the materials used to provide the coating. For example, siloxane particles such as, for example, polydimethylsiloxane (PDMS) particles, can be present as the coating material (or in the coating materials) or may be present in combination with one or more aqueous based coating materials. The particles can be suspended in the aqueous coating materials and may be co-deposited on a surface along with the other coating materials if desired. The particles may be functionalized with a compound selected from the group comprising organofunctional silane, parylene, fluorinated alkylsilane, fluorinated alkylsiloxane, fluorinated based organo-functional silane, fluorinated based organo-functional siloxane, organofunctional resins, hybrid inorganic organofunctional resins, silicone polymers, polydimethylsiloxane, organofunctional silicone polymers, organofunctional silicone copolymers, fluorinated organofunctional silicone copolymers, organo-functional oligomeric siloxane, fluorinated organo-functional oligomeric siloxane, organofunctional polyhedral oligomeric silsesquioxane (POSS), fluorinated polyhedral oligomeric silsesquioxane (FPOSS), fluorinated oligomeric polysiloxane, organofunctional oligomeric poly siloxane, fluorinated organofunctional silicone copolymers, organofunctional silicone polymers, hybrid inorganic organofunctional silicone polymers, organofunctional silicone copolymers, hybrid inorganic organofunctional silicone copolymers, non-volatile linear and branched alkanes, alkenes and alkynes; esters of linear and branched alkanes, alkenes and alkynes, perfluorinated organic material, silane coupling agents, organofunctional silane systems, and any combinations thereof.

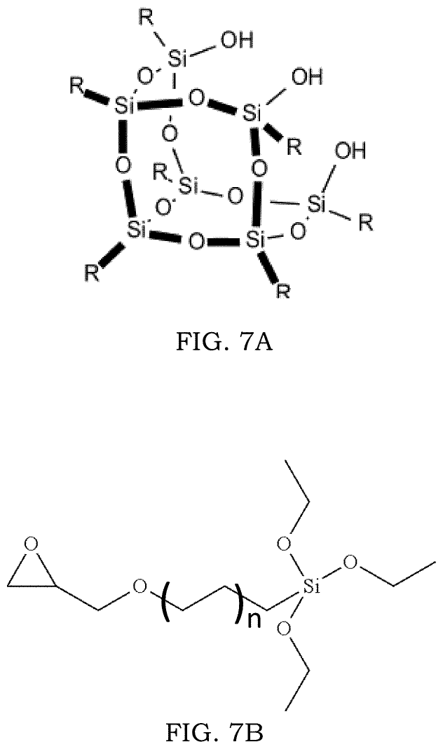

In certain instances, the organofunctional silane may comprise amino-functionalities, fluoro-functionalities or both. Similarly, the functionalized silicon dioxide particles may comprise amino-functionalities, fluoro-functionalities or both. In some examples, one or both of the organofunctional silane and functionalized silicon dioxide particles may comprise a silanol group as noted in FIG. 7A. In addition to any reactive silanol groups that may be present on the organofunctional silane and/or functionalized silicon dioxide particles, one or more epoxy groups may also be present and bonded to the silicon centers present in the organofunctional silane and/or the functionalized silicon dioxide particles. In other instances, one or more reactive epoxysilane groups as shown in FIG. 7B may be present in the materials used to provide the coating.

In some instances, the materials used to provide the coating may be a fluorine containing material as described for example in WO2017/112724, e.g., may be or may comprise hollow poly(vinylidene difluoride) microspheres. Additional fluorine containing materials such as polytetrafluoroethylene and other fluoropolymers may also be present as part of the materials used to provide the surface coating. As noted herein, where fluorinated materials are present, the fluorinated materials are selected so no off gassing results when the coating is heated up to 350 degrees Celsius.

In some examples, the materials used to provide the coating may comprise one or more materials commercially available from Evonik under the trade name SIVO. In other examples, the materials used to provide the coating may comprise one or more materials commercially available from Daikin including, but not limited to, POLYFLON PTFE enamel coatings, NEOFLON dispersion coatings, Unidyne Multi-Series™ such as Unidyne TG-5545 and Unidyne TG-5601, DAI-EL Latex fluoroelastomer coatings. The other examples are SILRES® BS 39 and TES 40 WN commercially available from Wacker or Sureco and AsahiGuard E-SERIES™ commercially available from AGC Chemicals Company. In other instances, the materials used to provide the coating may comprise polytetrafluorethylene (PTFE). The materials may also comprise mixtures of any of these illustrative materials as well.

In certain examples, the materials used to provide the coating may comprise compounds that include, but are not limited to, carbon, fluorine, and silicon. Moreover, the formed coating can form covalent bonds with the surface. A non-limiting illustration of one bonding mechanism is shown below:

-M-O—+RO—Si(R,R′)—O—→-M-O—Si(R,R′)—O—

where M is the constituent of the surface such as, for example, a metal and R and R′ represent hydrocarbon groups. The polymeric constituents of the mixture can cross-link. A non-limiting illustration of the cross-link mechanisms is the one shown below:

—O—Si(R,R′)O(R″)+(R′,R,R″)Si—O—R′″→—O—Si(R,R′)—O—R′″

where R, R′, R″ and R′″ independently represent hydrocarbon groups or other groups.

In some examples, the materials used to provide the coating may also comprise a surfactant such as, for example, alkylated and heavily alkylated quaternary ammonium salts, perfluorinated organo functional quaternary ammonium salts, Cetylpyridinium chloride, Lauryl methyl gluceth-10 hydroxypropyl dimonium chloride, Domiphen bromide, Benzododecinium bromide, Octenidine dihydrochloride, Fluoro-surfactant products, Sulfonates, Sulfates; Carboxylates for example Sodium stearate, Sodium lauroyl sarcosinate, Carboxylate-based fluorosurfactants such as Perfluorononanoate, Perfluorooctanoate (PFOA or PFO), Sodium alkylbenzene sulfonates, Sodium stearate, Potassium alcohol sulfates, Alcohol ethoxylates, Nonylphenoxy polyethylenoxy alcohols, Ethylene oxide/propylene oxide block copolymers, Fatty alcohol ethoxylates for example Narrow-range ethoxylate, Octaethylene glycol monododecyl ether, and Pentaethylene glycol monododecyl ether, Alkylphenol ethoxylates (APEs) for example Nonoxynols and Triton X-100, Special ethoxylated fatty esters and oils; Ethoxylated amines and/or fatty acid amides for example Polyethoxylated tallow amine, Cocamide monoethanolamine, and Cocamide diethanolamine; Terminally blocked ethoxylates for example Poloxamers, Fatty acid esters of polyhydroxy compounds, Fatty acid esters of glycerol for example Glycerol monostearate and Glycerol monolaurate, Fatty acid esters of sorbitol for example Sorbitan monolaurate, Sorbitan monostearate, and Sorbitan tristearate, Fatty acid esters of sucrose; Alkyl polyglucosides for example Decyl glucoside, Lauryl glucoside, and Octyl glucoside; Amine oxides for example Lauryldimethylamine oxide; Sulfoxides for example Dimethyl sulfoxide; Phosphine oxides for example Phosphine oxide, Sulfate, sulfonate, and phosphate esters; alkyl sulfates for example Ammonium lauryl sulfate and Sodium lauryl sulfate (sodium dodecyl sulfate, SLS, or SDS); Alkyl-ether sulfates for example sodium laureth sulfate (sodium lauryl ether sulfate or SLES), and sodium myreth sulfate; Docusate (dioctyl sodium sulfosuccinate); Perfluorooctanesulfonate (PFOS); Perfluorobutanesulfonate; Alkyl-aryl ether phosphates; Alkyl ether phosphates; pH-dependent primary, secondary, or tertiary amines; primary and secondary amines for example Octenidine dihydrochloride; Permanently charged quaternary ammonium salts for example Cetrimonium bromide (CTAB or Cetyltrimethyl ammonium bromide), Cetylpyridinium chloride (CPC), benzalkonium chloride (BAC), benzethonium chloride (BZT), dimethyldioctadecylammonium chloride, and dioctadecyldimethylammonium bromide (DODAB), and combinations thereof.

In some configurations, the materials described herein to provide the surface coatings are typically present in an aqueous based system during the deposition. For example, the materials may be dissolved in water that optionally contains one or more salts, particles, a surfactant or a dispersant. While organic solvents or other materials can also be present, the use of an aqueous based system to apply the materials reduces toxicity to provide a more environmentally friendly coating. The exact concentration of the materials in water may vary. Further, if desired, materials such as surfactants, dispersants or other materials may also be present to increase the water solubility of the materials that provide the resulting coating. Solvent, for example water, is typically removed during curing by heating of the applied coating material.

Material Application and Applicators

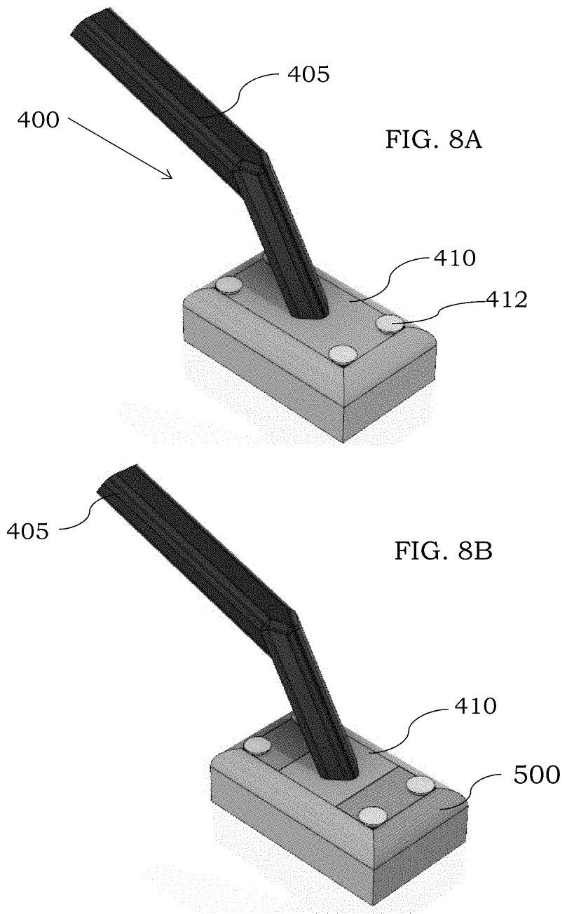

In some configurations, the wipe can be used with an applicator. FIGS. 8A-12A show different designs of illustrative applicators. In some instances, the applicator can make the application process of the coating easier or it can help the user to create more uniform coating on the surface. As shown in FIGS. 8A-12A, the wipe can be attached or coupled to the applicator using different mechanisms including buttons, and plastic pinch pins, hook and loop fastener or the wipe can be in the form of a sleeve that covers the applicator. Alternatively, the applicator may engage the wipe through a friction fit, and the applicator is designed to stay on top of the wipe during application of the coating. The applicator can comprise a sponge with or without a rigid backing. The applicator may or may not comprise a handle. In some examples, a sponge can be present between wipes with the sponge positioned in a pocket. For example, a first and second wipe can be heat sealed to another wipe to form a pocket. A sponge can be inserted into the pocket and used to retain some of the coating material. Referring to FIG. 8A, an applicator 400 comprising a handle 405 and a base 410 is shown. The base may optionally comprise a plurality of pins or other attachment means that can engage a wipe 500 as shown in FIG. 8B5. While not shown, the handle 405 may comprise a fluid reservoir that can hold the coating material and replenish the coating material to the wipe 500 through the base 410 as the coating material is being applied to the surface. The wipe 500 may comprise retained coating material, or the wipe 500 can be dipped into coating material after it is attached to the base 410.

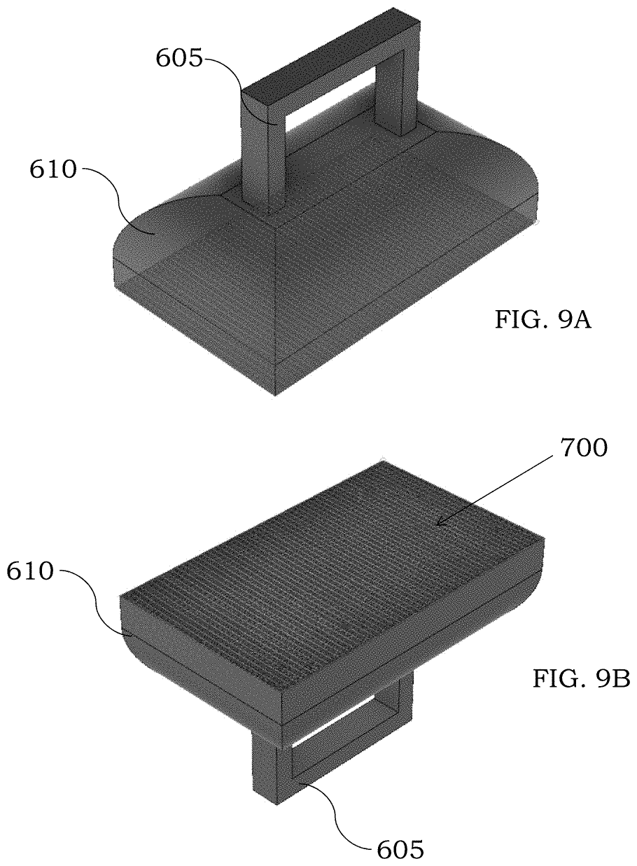

In other instances, an applicator can be configured as a block comprising a handle. Referring to FIGS. 9A and 9B, an applicator comprises a block 610 and a handle 605. The block 610 can be coupled to a wipe 700 using hook and loop fasteners or any other mechanism. The wipe 700 may comprise retained coating material, or the wipe 700 can be dipped into coating material after it is attached to the block 610. If desired, an underlying surface of the block 610 can be used to pre-treat the surface prior to applying the coating material. For example, a sponge or other material can be present on a surface of the block 610 where the wipe 700 couples.

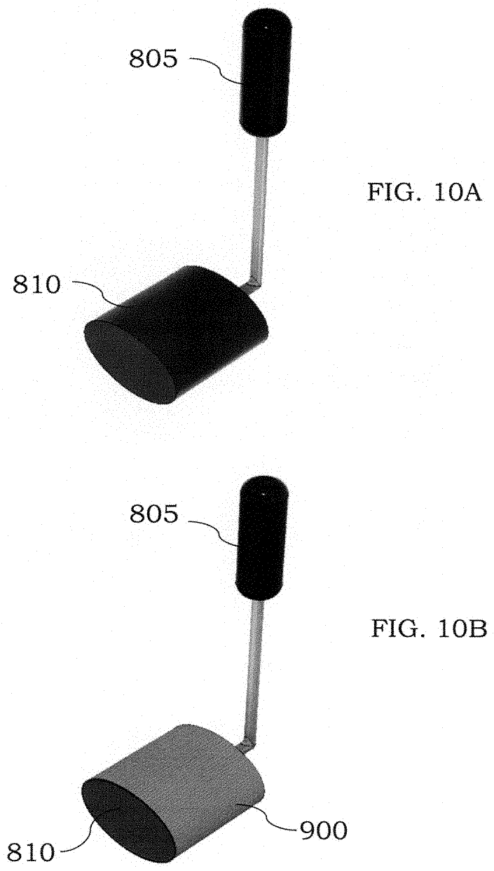

In another configuration, an applicator can be configured to receive a sleeve shaped wipe. Referring to FIGS. 10A and 10B, an applicator comprises a handle 805 and a base 810. The base can be configured as a cylinder or elliptical cylinder to receive sleeve shaped wipe 900. Further, the base 810 may be rotatable around the handle 805 or may be fixed. Where rotatable, the base 810 can be used to roll the coating material into a surface. The wipe 900 may comprise retained coating material, or the wipe 900 can be dipped into coating material after it is attached to the base 810.

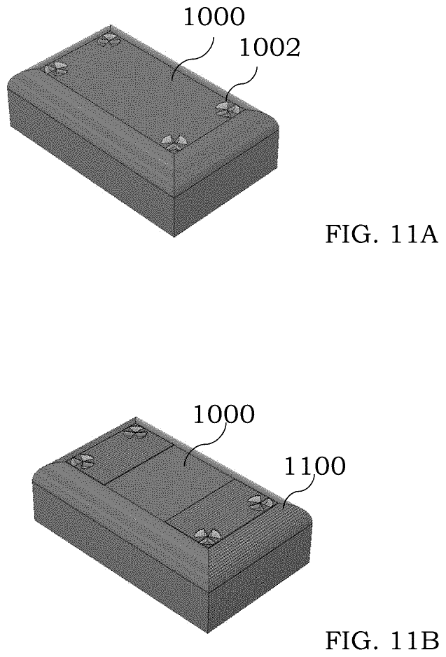

In some examples, the applicator may not comprise a handle. For example and referring to FIGS. 11A and 11B, a block applicator 1000 is shown that can couple to a wipe 1100 through pins (such as pin 1002), through a friction fit, through hook and loop fasteners, or other means. The wipe 1100 may comprise retained coating material, or the wipe 1100 can be dipped into coating material after it is attached to the block applicator 1000.

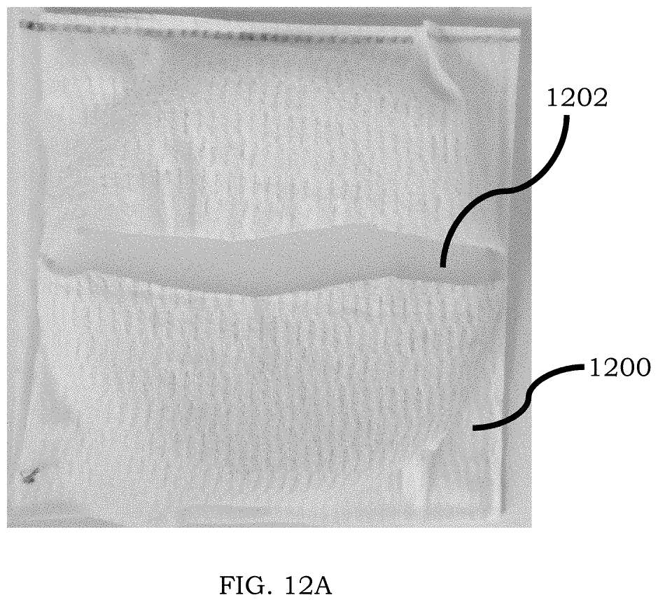

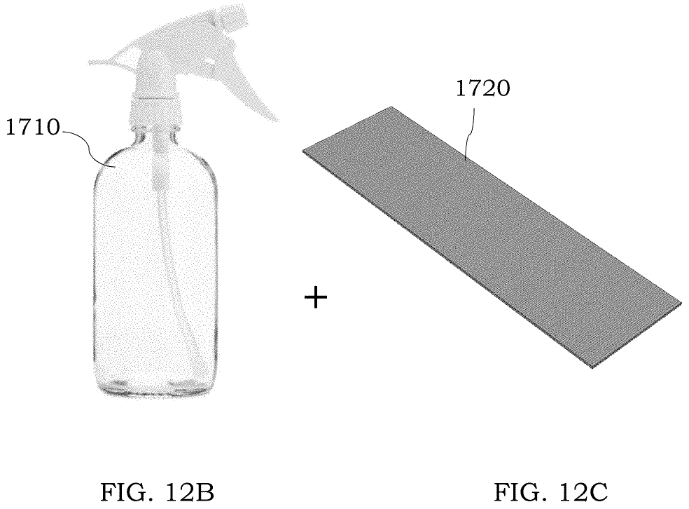

In another configuration, the wipe is made in the form of a cover on top of a sponge. For example and referring to FIG. 12A, a wipe 1200 covers a sponge 1202. The wipe 1200 is made by heat sealing or sewing two smaller wipes together. The wipe on the front can be similar or different than the wipe covering the back of the sponge. The sponge can then be inserted into the pocket formed by the wipes.

In other examples, the coating material can be present in kit that comprises a spray bottle and a wipe, which may be dry or may comprise the coating material. Referring to FIGS. 12B and 12C, a spray bottle 1710 and a wipe 1720 are shown. The spray bottle 1710 may comprise the coating material and can be used to spray coating material on the wipe 1720 or directly on a surface to be coated.

In some configurations, the applicator and/or wipe can apply a coating material to many different types and kinds of surfaces. For example, the coating can be applied on any surface including but not limited to metals, plastics, glass and ceramics. Stay-clean ovens usually include vitreous enamel. The coating should provide a proper dispersion onto the surface. Proper dispersion is identified by a contact angle of less than 50 degrees between a droplet of the mixture and the surface. Depending on the chemistry of the coating material(s) and type of the surface, the proper dispersion on the surface may be provided without the need for the advanced cleaning or treatment of the surface, e.g., little or no surface pre-treatment may occur. In some cases, cleaning and/or treating the surface may be desired to assist in the dispersion of the coating. Cleaning and/or treating the surface can be performed before applying the wipe using such compounds as organic solvents comprising toluene, ethanol, iso-propanol, and acetone, water, acidic solution comprising aqueous solution of organic and/or inorganic acids comprising but not limited to hydrochloric acid, phosphoric acid, oxalic acid, sulfuric acid, and citric acid; alkaline solution comprising but not limited to aqueous solution of sodium hydroxide, potassium hydroxide, ammonium hydroxide, tetramethyl ammonium hydroxide; cerium oxide paste comprising cerium oxide particles and water, an oxide comprising SiO2, Al2O3, Fe2O, In2O3, SnO2, ZrO2, B2O3, and TiO2, hydrolysable organometallic compounds, wherein the metal of the organometallic compounds is selected from a group including but not limited to titanium, zirconium, aluminum, iron, hafnium, niobium, tungsten and silicon, and any combinations thereof. Other materials and compounds can also be used to clean and/or pre-treat the surface. Further, physical pre-treatment using sand-blasting, sanding, polishing, etc. could also be performed if desired. Further, any of these materials can be mixed with the coating material to facilitate deposition of the coating material.

In some examples, a curing process may be needed for the wipe coating at a temperature in the range of 100 degrees Celsius to 400 degrees Celsius for a period of 5 minutes to 24 hours. The heating process can result in evaporation of the solvent from the coating material and provide a heat-cured coating. The curing process can occur at constant or variable temperatures. It can have one or multiple heating steps.

The materials, articles and methods described herein can be used in many different applications. For example, coatings can be applied to different surfaces of cooking ovens including residential ovens, commercial ovens, recreational vehicle ovens, semiconductor processing ovens, combi-ovens or other ovens that are heated up to 350 degrees Celsius. For example, surface coatings can be provided on at least one surface of a convection oven, a conventional oven, a pizza oven, microwave oven, combi-oven, and a steam oven. The heating source of the oven can be microwave, electric or gas. The oven can have any configuration of the heating element. As an instance, it can have exposed heating element on the bottom of the oven, or the heating element might be covered with one or more panels or enclosures. The coating can be applied on at least one surface or all surfaces of the oven cavity, including the surface bellow the heating element in ovens with exposed heating elements. In addition, the coating can be applied on both glass part and the ceramic or metal part of the door of the oven. The coating can be applied on the surfaces inside ovens regardless of their material composition. These surfaces can be made of metals for example stainless steel, or ceramic for example vitreous enamel, or glass. The coating may also be applied to insert or liners that may be present below gas burner elements such as those used in gas cooktops in residential, commercial and recreational vehicle settings to facilitate cleaning of the inserts or liners.

Processes Used to Provide Coatings

In certain embodiments, the exact process steps used to provide the coatings on the oven surfaces or article surfaces may vary. In general, the coating material is applied to the surface in some manner and then cured to provide the surface coating. If desired, repeated applications of the coating material on the surface can be performed prior to curing. For example, the surface coating materials can be deposited in a solution and permitted to dry on the surface. Additional coating material in the solution may then be deposited to build up the thickness of the surface coating material. The entire surface coating can then be cured using heat or other means. In other instances, coating material can be deposited on a surface and cured. Following curing, additional coating material can be deposited on the surface with the coating and cured. This process can be repeated a desired number of times.

In certain embodiments, a process for producing an oleophobic coating that does not off-gas any hazardous compounds when the oleophobic surface coating is heated to a temperature of 350 degree Celsius and provides easy-to-clean performance for at least ten repeated cycles of a cleanability test comprises depositing a coating material on a surface, and curing the deposited coating material to provide the oleophobic coating that provides the easy-to-clean performance for at least one cycle of the cleanability test. In some examples, the oleophobic coating provides the easy-to-clean performance for at least ten cycles of the cleanability test.

In certain examples, the process comprises depositing the coating material on the surface using an aqueous carrier. In other examples, the process comprises buffing the oleophobic coating on the surface. In additional examples, the process comprises heat curing the deposited coating material at a temperature between 100 degrees Celsius to 500 degrees Celsius. For example, heat curing can occur for a period of 5 minutes to 24 hours.

In some embodiments, the process may comprise preparing or pre-treating the surface prior to depositing the coating material. For example, pre-treating the surface can comprise cleaning or treating the surface using one an organic solvent, e.g., one or more of toluene, ethanol, iso-propanol, and acetone. In other instances, pre-treating the surface comprises cleaning or treating the surface using water or an aqueous solution. For example, an aqueous solution of organic and/or inorganic acids, e.g., an acidic solution comprising one or more of hydrochloric acid, phosphoric acid, oxalic acid, sulfuric acid, and citric acid, can be used. In other examples, the water or aqueous solution comprises an alkaline solution. For example, an alkaline solution comprising one or more of sodium hydroxide, potassium hydroxide, ammonium hydroxide, and tetramethyl ammonium hydroxide can be used.

In some examples, preparing or pre-treating the surface comprises cleaning or treating the surface using an oxide. For example, the oxide may comprise one or more of cerium oxide, SiO₂, Al₂O₃, Fe₂O, In₂O₃, SnO₂, ZrO₂, B₂O₃, and TiO₂. In other examples, preparing or pre-treating the surface comprises treating the surface with a hydrolyzable organometallic compounds, e.g., a metal of the hydrolyzable organometallic compound can comprise titanium, zirconium, aluminum, iron, hafnium, niobium, tungsten or silicon.

In other instances, the process may comprise depositing the coating material on the surface without any pre-treatment of the surface.

In some examples, the coating material provides proper dispersion on the surface after depositing the coating material, wherein the proper dispersion is identified by a contact angle of less than fifty degrees between a droplet of the coating solution and the surface as tested by ASTM D7490-13.

In some embodiments, the process may use a coating material that comprises one or more of parylene, organofunctional silanes, fluorinated organofunctional silane, fluorinated organofunctional siloxane, organo-functional oligomeric siloxane, organofunctional resins, hybrid inorganic organofunctional resins, low-surface-energy resins, organofunctional polyhedral oligomeric silsesquioxane (POSS), hybrid inorganic organofunctional POSS resins, fluorinated oligomeric polysiloxane, organofunctional oligomeric poly siloxane, hybrid inorganic organofunctional oligomeric poly siloxane, fluorinated organofunctional silicone copolymers, organofunctional silicone polymers, hybrid inorganic organofunctional silicone polymers, organofunctional silicone copolymers, hybrid inorganic organofunctional silicone copolymers, fluorinated polyhedral oligomeric silsesquioxane (FPOSS), non-volatile linear and branched alkanes, alkenes and alkynes; esters of linear and branched alkanes, alkenes and alkynes, perfluorinated organic material, silane coupling agents, fluorinated alkylsiloxane, organofunctional resins, hybrid inorganic organofunctional resins, silicone polymers, surface-modified inorganic particles, fluorinated alkylsilane, fluorinated based organo-functional silane, fluorinated based organo-functional siloxane, polydimethylsiloxane, fluorinated organo-functional oligomeric siloxane, polymer blends, aqueous preparations of an organofunctional silane system, organofunctional polysiloxane, silane based sol-gel system, fluoroalkysilane, hydrolyzable inorganic ethoxysilyl groups, sol-gel systems, silane system, functionalized silanol groups, other similar groups, aqueous, and alcohol-free products of epoxysilanes. In other instances, the process may use a coating material that comprises at least one type of particles comprising to silica (SiO2) particles, platinum oxide (Pt2O), alumina particles (Al2O3), silicon carbide (SiC), single wall carbon nanotubes (SWCNTs), multi-wall carbon nanotubes (MWCNTs), diatomaceous earth (DE), boron nitride (BN), titanium oxide (TiO2), mixture of titanium/silica oxide (TiO2/SiO2, titanium inner core/silicon outer surface), ceramic particles, thermo-chromic metal oxides, diamond, particles formed by differential etching of spinodal decomposed glass, molybdenum disulfide (MoS2), boron nitride (BN), sulfides, selenides and tellurides (chalcogenides) of molybdenum, tungsten, niobium, tantalum, and titanium (eg. WS2, WSe2, MoSe2, TaSe2, TiTe2), monochalcenides (GaS, GaSe, SnSe), chlorides of cadmium, cobalt, lead, cerium, zirconium (eg. CdCl2, CoC12, PbCl2, CeF3, PbI2), borates (eg. Na2B4O7) sulfates (eg. Ag2SO4), black carbon, carbon black, engineered carbon-based nanomaterials, e.g., carbon nanotubes, fullerenes, and graphene.

In some examples, the process may use a coating material or solution that comprises an organic solvent, e.g., the organic solvent comprises one or more of toluene, methanol, ethanol, iso-propanol, acetone, Propylene glycol methyl ether (PGME), Propylene glycol methyl ether acetate (PGMEA), ethyl lactate, Methyl ethyl ketone, and Methyl isobutyl ketone. In other examples, the process may use a coating material that comprises a surfactant, e.g., one or more of alkylated and heavily alkylated quaternary ammonium salts, perfluorinated organo functional quaternary ammonium salts, Cetylpyridinium chloride, Lauryl methyl gluceth-10 hydroxypropyl dimonium chloride, Domiphen bromide, Benzododecinium bromide, Octenidine dihydrochloride, Fluoro-surfactant products, Sulfonates, Sulfates; Carboxylates for example Sodium stearate, Sodium lauroyl sarcosinate, Carboxylate-based fluorosurfactants such as Perfluorononanoate, Perfluorooctanoate (PFOA or PFO), Sodium alkylbenzene sulfonates, Sodium stearate, Potassium alcohol sulfates, Alcohol ethoxylates, Nonylphenoxy polyethylenoxy alcohols, Ethylene oxide/propylene oxide block copolymers, Fatty alcohol ethoxylates for example Narrow-range ethoxylate, Octaethylene glycol monododecyl ether, and Pentaethylene glycol monododecyl ether, Alkylphenol ethoxylates (APEs) for example Nonoxynols and Triton X-100, Special ethoxylated fatty esters and oils; Ethoxylated amines and/or fatty acid amides for example Polyethoxylated tallow amine, Cocamide monoethanolamine, and Cocamide diethanolamine; Terminally blocked ethoxylates for example Poloxamers, Fatty acid esters of polyhydroxy compounds, Fatty acid esters of glycerol for example Glycerol monostearate and Glycerol monolaurate, Fatty acid esters of sorbitol for example Sorbitan monolaurate, Sorbitan monostearate, and Sorbitan tristearate, Fatty acid esters of sucrose; Alkyl polyglucosides for example Decyl glucoside, Lauryl glucoside, and Octyl glucoside; Amine oxides for example Lauryldimethylamine oxide; Sulfoxides for example Dimethyl sulfoxide; Phosphine oxides for example Phosphine oxide, Sulfate, sulfonate, and phosphate esters; alkyl sulfates for example Ammonium lauryl sulfate and Sodium lauryl sulfate (sodium dodecyl sulfate, SLS, or SDS); Alkyl-ether sulfates for example sodium laureth sulfate (sodium lauryl ether sulfate or SLES), and sodium myreth sulfate; Docusate (dioctyl sodium sulfosuccinate); Perfluorooctanesulfonate (PFOS); Perfluorobutanesulfonate; Alkyl-aryl ether phosphates; Alkyl ether phosphates; pH-dependent primary, secondary, or tertiary amines; primary and secondary amines for example Octenidine dihydrochloride; Permanently charged quaternary ammonium salts for example Cetrimonium bromide (CTAB or Cetyltrimethyl ammonium bromide), Cetylpyridinium chloride (CPC), benzalkonium chloride (BAC), benzethonium chloride (BZT), dimethyldioctadecylammonium chloride, and dioctadecyldimethylammonium bromide (DODAB).

In some embodiments, the coating material is deposited on the surface by dip coating the surface in a solution of the coating material. In other embodiments, the coating material is deposited on the surface by flow coating a solution of the coating material on the surface. In some examples, the coating material is deposited on the surface by spray coating a solution of the coating material on the surface. In additional examples, the coating material is deposited on the surface by spin coating a solution of the coating material on the surface. Additional methods to deposit the coating material on a surface will be recognized by the skilled person in the art, given the benefit of this disclosure.

Coating Properties

In certain embodiments, the coatings that result from application of the materials to the surface may comprise a thickness in the range of 0.01 micrometers to 100 micrometers. In some cases, the thickness across the surface is substantially uniform. Spreading of the coating materials using the wipe and/or applicators can increase the uniformity of the thickness across the surface. In some cases, some non-uniformity in the thickness of the coating may be observed depending on the way that the coating is applied on the surface. The easy-to-clean performance of the coating does not depend on its uniformity or its thickness. As noted herein, the surface coating also may be oleophobic, e.g., have a contact angle of more than 90 degrees using grape seed oil as tested by the ASTM D7490-13 standard. The surface coating may also exhibit easy-to-clean performance and/or not provide any off gassing of halogenated materials such as fluorinated materials. In some embodiments, the coating can exhibit a cross-linked mesh with an RMS roughness between 0.5 nm to 50 nm. The easy-to-clean performance of the coating does not depend on its roughness.

Certain specific coatings were produced and tested below using organfunctionalized silane systems by applying the coating using a wipe that retained the coating. The organfunctionalized silane systems that can be used will vary and typically water soluble organfunctionalized silane systems are desired to permit heat curing of the applied coating material.

### Example 1

As a non-limiting example, a thickness of around 70 nanometers was measured for a coating on an enamel surface. The oleophobic property of this coating was confirmed by a contact angle measurement test based on the ASTM D7490-13 standard. The contact angle measurements were performed using an Attension® Theta Lite Contact Angle measurement device and its software OneAttension Version 3.2 (r5971) from Biolin Scientific (Gothenburg, Sweden). An oleophobic property is present if the contact angle is more than 90 degree using grape seed oil.

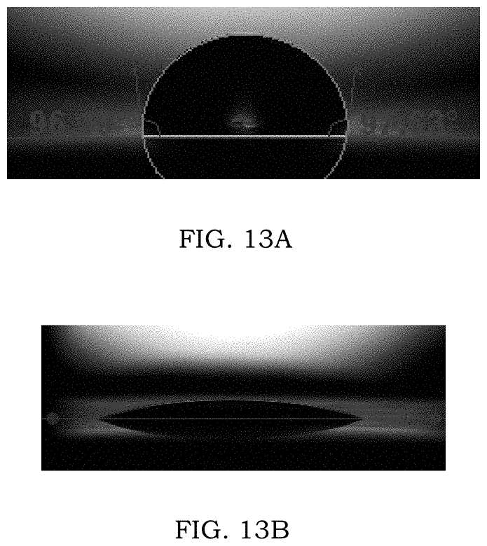

The tested coating exhibited a contact angle between 90° to 120° with grape seed oil. FIG. 13A shows the representative images of grape seed oil droplets on an enamel surface covered with the oleophobic coating, and FIG. 13B shows grape seed oil droplets on an un-coated enamel surface. As shown in FIG. 13B, grape seed oil completely wets the surface of uncoated enamel and provides a very low contact angle, while the contact angle of the grape seed oil with the coating (FIG. 13A) was measured to be around 97 degrees.

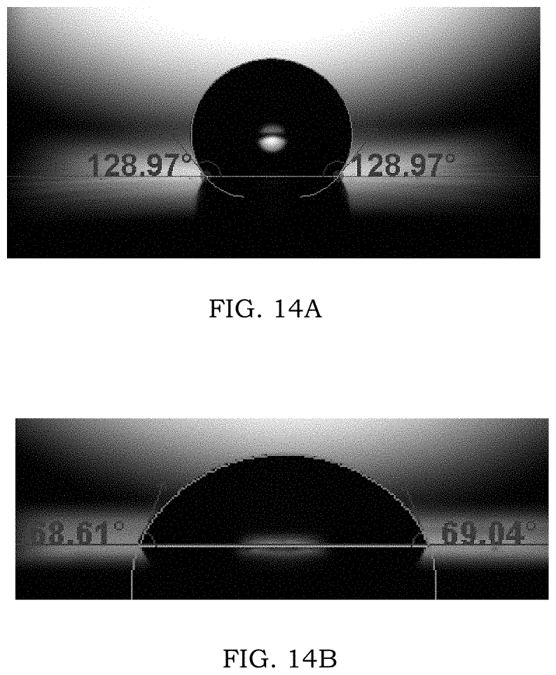

FIG. 14A shows an example of the contact angle of water droplets with an enamel surface covered with the oleophobic coating, and FIG. 14B shows an un-coated enamel surface. A contact angle of 129 degrees was measured for the coated surface, whereas a contact angle of 69 degrees was measured for the uncoated enamel surface.

### Example 2

In another test, the off-gassing characteristics of the coating was evaluated for its stability at high temperature and for detection of volatile chemical compounds released during the experiment using a gas chromatograph mass spectrometer (GC-MS) instrument. In this test the coating was heated to 350 degrees Celsius for 1 hour, and the gasses released from the coating were analyzed using the GC-MS.

The only measurable materials released from the coated enamel surface were water, cyclopentasiloxane decamethyl, and cyclohexasiloxane dodecamethyl. No outgassing of hazardous fluorinated gases was measured.

These results are consistent with the coating being suitable for many different industrial applications where not only it provides the desired hydrophobic and/or oleophobic properties but also is extremely safe for high temperature applications.

### Example 3

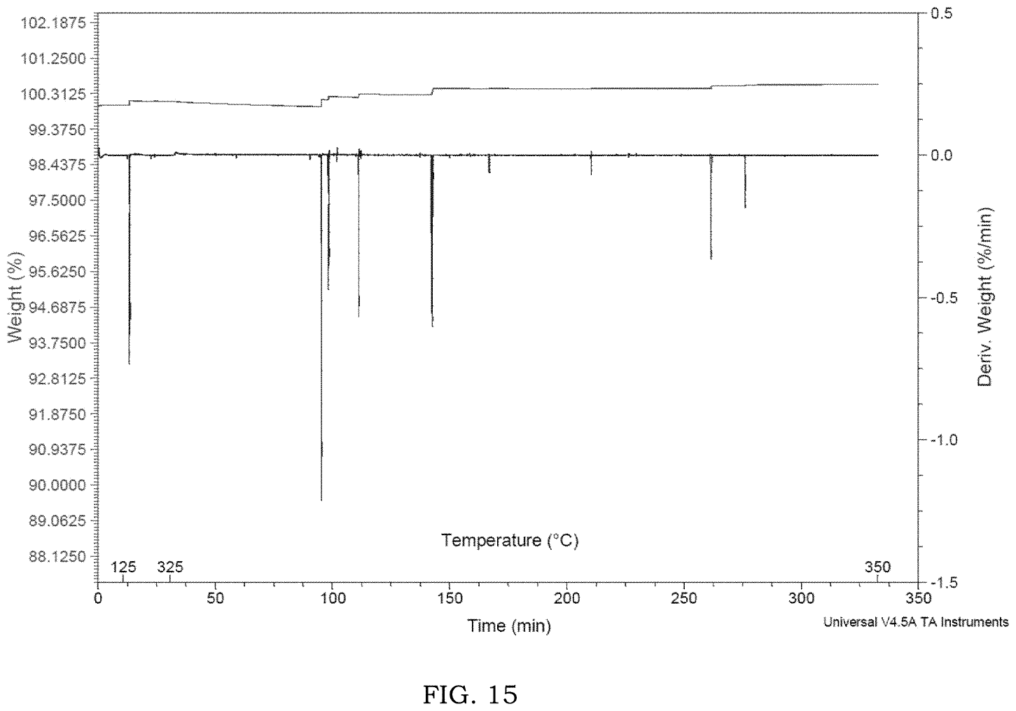

The heat resistance of the coating was also tested by Thermogravimetric Analysis (TGA). FIG. 15 is a graph showing TGA analysis of the coating. In this test, the coating was heated to 350 degrees Celsius at a rate of 10 degrees Celsius per minute. The coating was then held at 350 degrees Celsius for 5 hours. The weight of the sample was constantly measured in this process. As shown in FIG. 15, the coating did not exhibit any significant weight loss up to 350 degrees Celsius. The weight loss of the coating was less than 0.15 percent at temperatures between 300 degrees Celsius and 400 degrees Celsius.

Therefore, the coating is stable over this temperature range.

### Example 4

Another test was used to evaluate the coatings ability to be cleaned easily. Easy-to-clean performance was characterized by a cleanability test. The test consisted of adding around 1 gram of ketchup to the surface and burning the added ketchup at a temperature between 230 degrees Celsius to 300 degrees Celsius for 30 minutes to 1 hour. The burned ketchup residue was then cleaned. The surface is considered easy-to-clean if cleaning process with the following four steps can completely remove the residue of the burnt ketchup from the surface:
1—Cleaning is performed using a soft cloth or a Surface-care sponge; Cleaning Scouring Sponge or abrasive sponge such as Green 3M Sponge should not be used for cleaning.
2—Cleaning is performed either without any liquid or in the presence of hot water, mild detergent, or Liquid abrasive cleaner; Oven cleaner should not be used for cleaning.
3—The maximum allowable force for cleaning is 4 kgf.
4—The surface can be wiped up to 15 separate times for removing the residue.

If a cleaning process that satisfies above requirements can completely remove the residue of the burnt ketchup, the surface is considered easy-to-clean or provides easy-to-clean performance for the cycle.

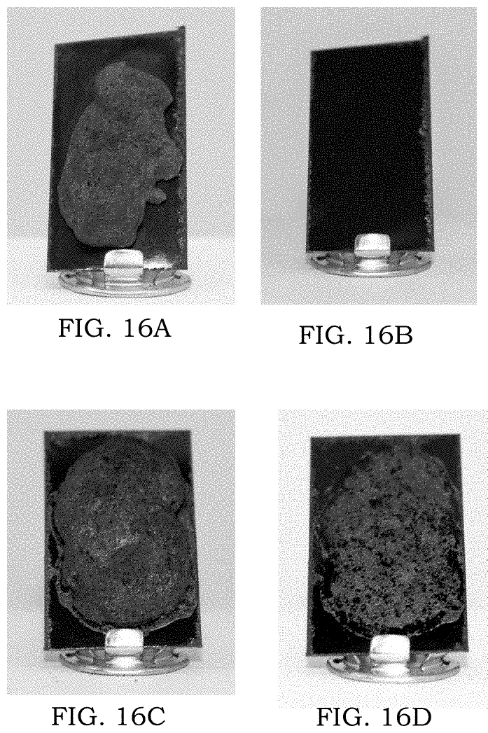

The cleanability test was performed on an enamel surface including the coating (FIG. 16A and FIG. 16B) and on an uncoated enamel surface (FIG. 16C and FIG. 16D). As shown in FIGS. 16A and 16C, ketchup on both of the coated and uncoated surfaces was completely burnt after 30 minutes of heating at 250 degrees Celsius. Burnt ketchup strongly adhered to the control sample (untreated enamel surface of FIG. 16C) and could not be removed even using an abrasive sponge (see FIG. 16D). In contrast, burnt ketchup residue easily was removed from the treated enamel surface (see FIG. 16B) by a gentle tapping or by using a dry soft cloth.

### Example 5

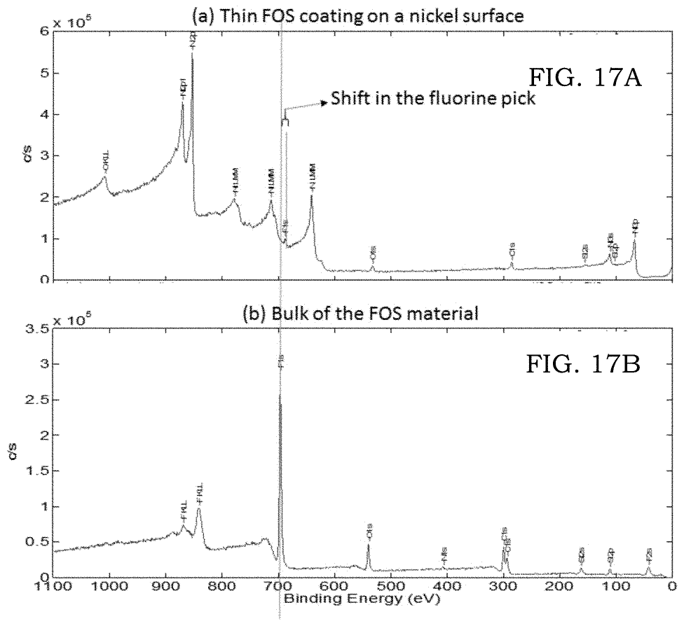

The formation of a covalent bond between the coating and the surface was verified using X-Ray Photoelectron Spectroscopy (XPS). FIGS. 17A and 17B compares the XPS spectrum of a very thin coating close to the surface (FIG. 17A) with that of the bulk of the coating (FIG. 17B). The clear shift in binding energy corresponding to a fluorine peak is associated with a chemical bond formation between the surface and the coating. This bond is believed to be a strong covalent bond.

### Example 6

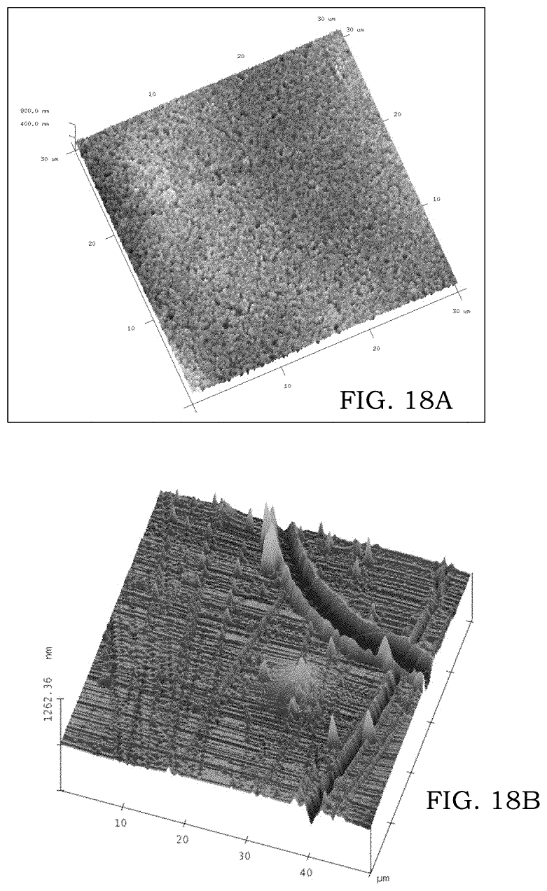

The coating structure can exhibit a cross-linked mesh with an RMS roughness between 0.5 nm to 50 nm. As a non-limiting example, roughness between 3 nm to 40 nm was measured for the coating when the surface was an enamel surface with the roughness of 1 nm to 2.5 nm. FIGS. 18A and 18B shows two images of the 3D structure of the coating taken by Atomic Force Microscopy.

### Example 7

A 4.5 in by 4.5 in wipe was used to coat an oven panel having dimensions of 18″×28″. The oven was used for four hours (four cooking cycles of one hour) at the temperature of 230 C. The same wipe was then used to reapply the coating on the panel. After reapplication of the coating, again the oven was used for four cooking cycles of one hours (in total four hours) at the temperature of 230 C. The reapplication was repeated five times using a single wipe and the surface remained easy-to-clean throughout the entire time of this test. This test is consistent with a single wipe being capable of providing an easy-to-clean coating on the bottom surface of the oven even after 20 total hours of cooking. The wipe can be stored in its original closed bag after each use, so it can be used for subsequent application of the coating material if desired.

### Example 8

The wipe of Example 7 was used to apply a coating on the bottom surface of an oven. The oven was then used for eight cooking cycles of one hour at the temperature of 230 degrees Celsius. It was found that the surface remained easy-to-clean up to eight cooking cycles.

### Example 9

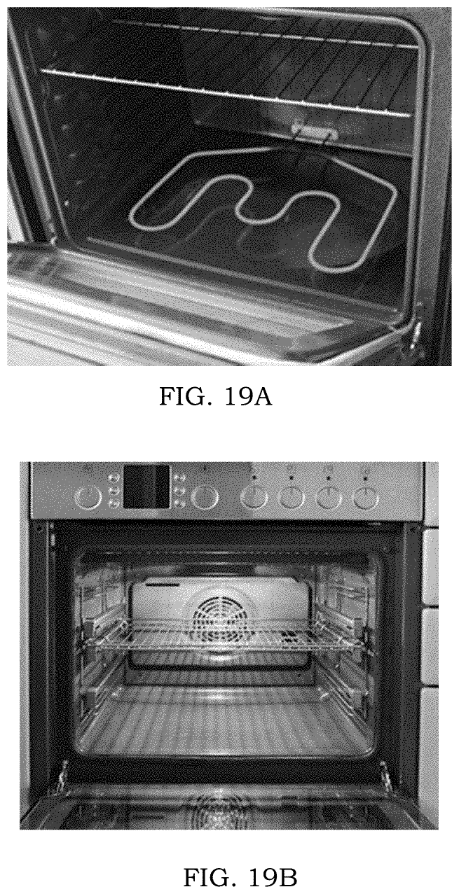

The surface coatings described herein can be provided to oven surface which include an exposed bottom heating elements (FIG. 19A) or those where the bottom heating element is covered by a panel (FIG. 19B). In either case, the oven typically includes a lower surface that comprises enamel.

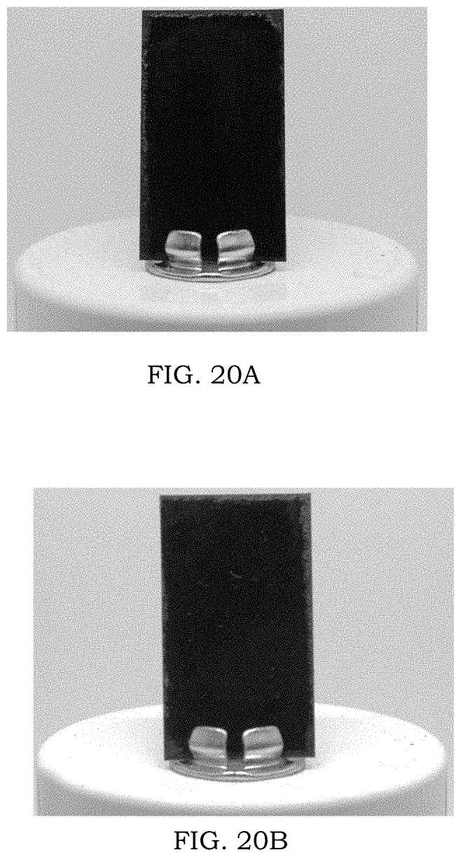

Cleanability on an enamel surface was tested. FIG. 20A shows an image of the coated enamel surface before the cleanability test, and FIG. 20B shows the coated enamel surface after ten cycles of the cleanability test. After 10 repeated cycles of the cleanability test, the surface is still easy-to-clean, and the soil of the burnt ketchup can be completely removed from the surface following the cleaning process explained before. Though ketchup is used in the cleanability test, the easy-to-clean performance of the coating has also been tested and verified using other types of the food including but not limited to jam, cake batter, olive oil, and chicken fat.

When introducing elements of the examples disclosed herein, the articles “a,” “an,” “the” and “said” are intended to mean that there are one or more of the elements. The terms “comprising,” “including” and “having” are intended to be open-ended and mean that there may be additional elements other than the listed elements. It will be recognized by the person of ordinary skill in the art, given the benefit of this disclosure, that various components of the examples can be interchanged or substituted with various components in other examples.

Although certain aspects, examples and embodiments have been described above, it will be recognized by the person of ordinary skill in the art, given the benefit of this disclosure, that additions, substitutions, modifications, and alterations of the disclosed illustrative aspects, examples and embodiments are possible.

1. An oven comprising a cooking cavity and an oleophobic surface coating on at least one surface of the cooking cavity, wherein the oleophobic surface coating provides easy-to-clean performance in a cleanability test for at least ten cycles and does not off gas any halogenated compounds when the surface comprising the oleophobic surface coating is heated to a temperature of 350 degree Celsius.

2. The oven of claim 1, wherein the oleophobic surface coating comprises one or more of parylene, an organofunctional silane, a fluorinated organofunctional silane, fluorinated organofunctional siloxane, organo-functional oligomeric siloxane, organofunctional resins, hybrid inorganic organofunctional resins, low-surface-energy resins, organofunctional polyhedral oligomeric silsesquioxane (POSS), hybrid inorganic organofunctional POSS resins, fluorinated oligomeric polysiloxane, organofunctional oligomeric poly siloxane, hybrid inorganic organofunctional oligomeric poly siloxane, fluorinated organofunctional silicone copolymers, organofunctional silicone polymers, hybrid inorganic organofunctional silicone polymers, organofunctional silicone copolymers, hybrid inorganic organofunctional silicone copolymers, fluorinated polyhedral oligomeric silsesquioxane (FPOSS), non-volatile linear and branched alkanes, alkenes and alkynes, esters of linear and branched alkanes, alkenes and alkynes, perfluorinated organic material, silane coupling agents, fluorinated alkylsiloxane, organofunctional resins, hybrid inorganic organofunctional resins, silicone polymers, surface-modified inorganic particles, fluorinated alkylsilane, fluorinated based organo-functional silane, fluorinated based organo-functional siloxane, polydimethylsiloxane, fluorinated organo-functional oligomeric siloxane, polymer blends, aqueous preparation of an organofunctional silane system, organofunctional polysiloxane, silane based sol-gel system, fluoroalkysilane, hydrolyzable inorganic ethoxysilyl groups, sol-gel systems, silane system, functionalized silanol groups, other similar groups, aqueous, alcohol-free products of epoxysilanes, or any combination thereof.

3. The oven of claim 1, wherein the oleophobic surface coating comprises a material comprising carbon, fluorine, and silicon to provide an oleophobic surface coating that is a crosslinked mesh on the surface.

4. The oven of claim 1, wherein the oleophobic surface coating comprises at least particle comprising silica (SiO2) particles, platinum oxide (Pt2O), alumina particles (Al2O3), silicon carbide (SiC), single wall carbon nanotubes (SWCNTs), multi-wall carbon nanotubes (MWCNTs), diatomaceous earth (DE), boron nitride (BN), titanium oxide (TiO2), mixture of titanium/silica oxide (TiO2/SiO2, titanium inner core/silicon outer surface), ceramic particles, thermo-chromic metal oxides, diamond, particles formed by differential etching of spinodal decomposed glass, molybdenum disulfide (MoS2), boron nitride (BN), sulfides, selenides and tellurides (chalcogenides) of molybdenum, tungsten, niobium, tantalum, and titanium (eg. WS2, WSe2, MoSe2, TaSe2, TiTe2), monochalcenides (GaS, GaSe, SnSe), chlorides of cadmium, cobalt, lead, cerium, zirconium (eg. CdCl2, CoC12, PbCl2, CeF3, PbI2), borates (eg. Na2B4O7) sulfates (eg. Ag2SO4), black carbon, carbon black, engineered carbon-based nanomaterials, e.g., carbon nanotubes, fullerenes, graphene and any combination thereof.

5. The oven of claim 4, wherein the particles are functionalized with a compound selected from the group comprising organofunctional silane, parylene, fluorinated alkylsilane, fluorinated alkylsiloxane, fluorinated based organo-functional silane, fluorinated based organo-functional siloxane, organofunctional resins, hybrid inorganic organofunctional resins, silicone polymers, polydimethylsiloxane, organofunctional silicone polymers, organofunctional silicone copolymers, fluorinated organofunctional silicone copolymers, organo-functional oligomeric siloxane, fluorinated organo-functional oligomeric siloxane, organofunctional polyhedral oligomeric silsesquioxane (POSS), fluorinated polyhedral oligomeric silsesquioxane (FPOSS), fluorinated oligomeric polysiloxane, organofunctional oligomeric poly siloxane, fluorinated organofunctional silicone copolymers, organofunctional silicone polymers, hybrid inorganic organofunctional silicone polymers, organofunctional silicone copolymers, hybrid inorganic organofunctional silicone copolymers, non-volatile linear and branched alkanes, alkenes and alkynes, esters of linear and branched alkanes, alkenes and alkynes, perfluorinated organic material, silane coupling agents, organofunctional silane systems, and any combinations thereof.

6. The oven of claim 1, wherein the oleophobic surface coating comprises a surfactant comprising one or more of alkylated and heavily alkylated quaternary ammonium salts, perfluorinated organo functional quaternary ammonium salts, Cetylpyridinium chloride, Lauryl methyl gluceth-10 hydroxypropyl dimonium chloride, Domiphen bromide, Benzododecinium bromide, Octenidine dihydrochloride, Fluoro-surfactant products, Sulfonates, Sulfates, Carboxylates, Sodium stearate, Sodium lauroyl sarcosinate, Carboxylate-based fluorosurfactants such as Perfluorononanoate, Perfluorooctanoate (PFOA or PFO), Sodium alkylbenzene sulfonates, Sodium stearate, Potassium alcohol sulfates, Alcohol ethoxylates, Nonylphenoxy polyethylenoxy alcohols, Ethylene oxide/propylene oxide block copolymers, Fatty alcohol ethoxylates, Narrow-range ethoxylate, Octaethylene glycol monododecyl ether, and Pentaethylene glycol monododecyl ether, Alkylphenol ethoxylates (APEs), Nonoxynols and Triton X-100, Special ethoxylated fatty esters and oils, Ethoxylated amines and/or fatty acid amides, Polyethoxylated tallow amine, Cocamide monoethanolamine, and Cocamide diethanolamine, Terminally blocked ethoxylates, Poloxamers, Fatty acid esters of polyhydroxy compounds, Fatty acid esters of glycerol, Glycerol monostearate and Glycerol monolaurate, Fatty acid esters of sorbitol, Sorbitan monolaurate, Sorbitan monostearate, and Sorbitan tristearate, Fatty acid esters of sucrose, Alkyl polyglucosides, Decyl glucoside, Lauryl glucoside, and Octyl glucoside, Amine oxides, Lauryldimethylamine oxide, Sulfoxides, Dimethyl sulfoxide, Phosphine oxides, Phosphine oxide, Sulfate, sulfonate, and phosphate esters, alkyl sulfates, Ammonium lauryl sulfate and Sodium lauryl sulfate (sodium dodecyl sulfate, SLS, or SDS), Alkyl-ether sulfates, sodium laureth sulfate (sodium lauryl ether sulfate or SLES), and sodium myreth sulfate, Docusate (dioctyl sodium sulfosuccinate), Perfluorooctanesulfonate (PFOS), Perfluorobutanesulfonate, Alkyl-aryl ether phosphates, Alkyl ether phosphates, pH-dependent primary, secondary, or tertiary amines, primary and secondary amines, Octenidine dihydrochloride, Permanently charged quaternary ammonium salts, Cetrimonium bromide (CTAB or Cetyltrimethyl ammonium bromide), Cetylpyridinium chloride (CPC), benzalkonium chloride (BAC), benzethonium chloride (BZT), dimethyldioctadecylammonium chloride, and dioctadecyldimethylammonium bromide (DODAB).

7. The oven of claim 1, wherein the oleophobic surface coating comprises a thickness between 0.01 micrometers to 100 micrometers.

8. The oven of claim 1, wherein the oleophobic surface coating comprises a water contact angle between 100 degrees and 150 degrees as tested by ASTM D7490-13 using distilled water.

9. The oven of claim 1, wherein the oleophobic surface coating comprises an organofunctional silane system.

10. The oven of claim 1, wherein the oleophobic surface coating comprises an epoxysilane.

11. The oven of claim 1, wherein the oleophobic surface coating is produced by contacting the surface with a wipe comprising a carrier material and a coating material retained by the carrier material to transfer at least some of the retained coating material from the wipe to the contacted surface, and heat curing the transferred coating material on the contacted surface to provide the oleophobic surface coating that provides the easy-to-clean performance in the cleanability test for at least ten cycles and does not off-gas any hazardous compounds when the surface comprising the oleophobic surface coating is heated to a temperature of 350 degree Celsius.

12. The oven of claim 1, wherein the oven comprises an exposed lower heating element in the cooking cavity, wherein the oleophobic surface coating is present on a surface below the exposed lower heating element.

13. The oven of claim 1, wherein the oven comprises a panel covering a lower heating element in the cooking cavity, wherein the oleophobic surface coating is present on a top surface of the panel.

14. The oven of claim 1, wherein the oven is a combi-oven.

15. The oven of claim 1, wherein the oven is a recreational vehicle oven.

16. The oven of claim 1, wherein the oven is a microwave oven.

17. The oven of claim 1, wherein the oven is a semi-conductor processing oven.

18. The oven of claim 1, wherein the oven is a residential oven comprising a cooktop, wherein the residential oven is configured to heat the cooking cavity to a temperature up to about 290 degrees Celsius.

19. The oven of claim 18, further comprising an oleophobic surface coating on a surface of the cooktop.

20. The oven of claim 19, wherein the oleophobic surface coating on the surface of the cooktop provides easy-to-clean performance in a cleanability test for at least one cycle and does not off gas any halogenated compounds when the cooktop surface comprising the oleophobic surface coating is heated up to about 300 degrees Celsius.

21-82. (canceled)
